(19) United States
(12) Patent Application Publication
(10) Pub. No.: US 2017/0175276 A1
(43) Pub. Date: Jun. 22, 2017

(54) NANOSTRUCTURED ELECTRODES AND METHODS OF MAKING AND USE THEREOF

(71) Applicant: Board of Regents, The University of Texas System, Austin, TX (US)

(72) Inventors: Yuebing Zheng, Austin, TX (US); Jiayong Gan, Round Rock, TX (US)

(21) Appl. No.: 15/376,760

(22) Filed: Dec. 13, 2016

Related U.S. Application Data
(60) Provisional application No. 62/269,207, filed on Dec. 18, 2015.

(51) Int. Cl. C25B 1/00; C25B 11/04; H01G 9/20; C04B 35/64; C25D 7/12; C25D 5/50; C04B 35/622; C25B 1/04; C25D 9/04

(52) U.S. Cl. CPC C25B 1/003; C25B 1/04; C25B 11/04; H01G 9/2054; H01G 9/204; H01G 9/2036; H01G 9/2031; C25D 9/04; C25D 7/12; C25D 5/50; C04B 35/62218; C04B 35/64

(57) ABSTRACT

Disclosed herein are nanostructured electrodes comprising a plurality of plasmonic particles having a plasmon resonance energy in electromagnetic contact with a nanostructured semiconductor having a band gap with a conduction band. In some examples, at least a portion of the plasmon resonance energy of the plurality of plasmonic particles is higher in energy than the conduction band of the nanostructured semiconductor. In some examples, the plasmon resonance energy of the plurality of plasmonic particles can at least partially overlap with the band gap of the nanostructured semiconductor. Also disclosed herein are methods of making and methods of using the nanostructured electrodes described herein.

### CROSS-REFERENCE TO RELATED APPLICATIONS

This application claims the benefit of U.S. Provisional Application No. 62/269,207, filed Dec. 18, 2015, which is hereby incorporated herein by reference in its entirety.

### BACKGROUND

Due to the ever-increasing consumption rate of energy world-wide, scientists and engineers are seeking to harness renewable energy sources such as sunlight, wind, geothermal heat, tides, and biomass. Among the various available options, solar energy is an attractive option to provide long-term sustainable energy. As exemplified by photosynthesis in plants, sunlight can be harnessed to produce oxygen and carbohydrates from water and carbon dioxide. This energy conversion via photosynthesis in plants occurs with an energy conversion efficiency of up to 7%.

Inspired by nature, researched have been exploring artificial photosynthesis in various forms for the solar-to-chemical energy conversion. The use of photoelectrochemical (PEC) cells is a promising strategy for capturing and chemically storing solar energy while tackling environmental issues. PEC cells utilize sunlight to optically excite to drive water splitting and thereby extract hydrogen and oxygen from water.

Though the concept of photoelectrochemical cells has been explored since 1972 (Fujishima A and Honda K. Nature 1972, 37), the real-life incorporation of robust and efficient cells has been challenging. One of the main barriers is the challenge of developing cheap, efficient, and stable photoanode materials. The nanostructured electrodes discussed herein address these and other needs

### SUMMARY

Disclosed herein are nanostructured electrodes. The nanostructured electrodes can, for example, comprise a plurality of plasmonic particles having a plasmon resonance energy in electromagnetic contact with a nanostructured semiconductor having a band gap with a conduction band. In some examples, the plurality of plasmonic particles can comprise a plurality of metal particles. The plurality of metal particles can, for example, comprise a metal selected from the group consisting of Au, Ag, Pt, Pd, Cu, Al, and combinations thereof. In some examples, the plurality of plasmonic particles can comprise a plurality of gold particles.

The plurality of plasmonic particles can have an average particle size of from 8 nm to 80 nm (e.g., from 8 nm to 40 nm, from 15 nm to 40 nm, from 25 nm to 35 nm). In some examples, the plurality of plasmonic particles are substantially spherical.

In some examples, the nanostructured semiconductor can comprise a metal oxide, a metal sulfide, a metal selenide, a metal nitride, or combinations thereof. The nanostructured semiconductor can, for example, comprise Fe₂O₃, WO₃, Ta₃N₅, TaON, TiO₂, ZnO, CdS, CdSe, BiVO₄, or combinations thereof.

In some examples, the nanostructured semiconductor can comprise a metal oxide. The metal oxide can, in some examples, comprise a mixed metal oxide (e.g., with different metal elements). The metal oxide can, for example, comprise a metal selected from the group consisting of Be, Mg, Al, Ca, Sc, Ti, V, Cr, Mn, Fe, Co, Ni, Cu, Zn, Ga, Sr, Y, Zr, Nb, Mo, Tc, Ru, Rh, Pd, Ag, Cd, In, Sn, Ba, Hf, Ta, W, Re, Os, Ir, Pt, Au, Hg, Tl, Pb, Bi, La, Ce, Pr, Nd, Pm, Sm, Eu, Gd, Tb, Dy, Ho, Er, Tm, Yb, and combinations thereof. In some examples, the nanostructured semiconductor comprises BiVO₄.

In some examples, the nanostructured semiconductor can comprise a metal sulfide. The metal sulfide can, for example, comprise a metal selected from the group consisting of Be, Mg, Al, Ca, Sc, Ti, V, Cr, Mn, Fe, Co, Ni, Cu, Zn, Ga, Sr, Y, Zr, Nb, Mo, Tc, Ru, Rh, Pd, Ag, Cd, In, Sn, Ba, Hf, Ta, W, Re, Os, Ir, Pt, Au, Hg, Tl, Pb, Bi, La, Ce, Pr, Nd, Pm, Sm, Eu, Gd, Tb, Dy, Ho, Er, Tm, Yb, and combinations thereof.

In some examples, the nanostructured semiconductor can comprise a metal selenide. The metal selenide can, for example, comprise a metal selected from the group consisting of Be, Mg, Al, Ca, Sc, Ti, V, Cr, Mn, Fe, Co, Ni, Cu, Zn, Ga, Sr, Y, Zr, Nb, Mo, Tc, Ru, Rh, Pd, Ag, Cd, In, Sn, Ba, Hf, Ta, W, Re, Os, Ir, Pt, Au, Hg, Tl, Pb, Bi, La, Ce, Pr, Nd, Pm, Sm, Eu, Gd, Tb, Dy, Ho, Er, Tm, Yb, and combinations thereof.

In some examples, the nanostructured semiconductor can comprise a metal nitride. The metal nitride can, for example, comprise a metal selected from the group consisting of Be, Mg, Al, Ca, Sc, Ti, V, Cr, Mn, Fe, Co, Ni, Cu, Zn, Ga, Sr, Y, Zr, Nb, Mo, Tc, Ru, Rh, Pd, Ag, Cd, In, Sn, Ba, Hf, Ta, W, Re, Os, Ir, Pt, Au, Hg, Tl, Pb, Bi, La, Ce, Pr, Nd, Pm, Sm, Eu, Gd, Tb, Dy, Ho, Er, Tm, Yb, and combinations thereof.

The nanostructured semiconductor can, for example, comprise a continuous semiconductor phase comprising a plurality of semiconductor particles. The plurality of semiconductor particles can, for example, have an average particle size of from 20 nm to 120 nm (e.g., from 60 nm to 80 nm). In some examples, the plurality of semiconductor particles are substantially spherical in shape.

In some examples, at least a portion of the plasmon resonance energy of the plurality of plasmonic particles is higher in energy than the conduction band of the nanostructured semiconductor. In some examples, the plasmon resonance energy of the plurality of plasmonic particles can at least partially overlap with the band gap of the nanostructured semiconductor.

The nanostructured electrode can, in some examples, have a BET surface area of from 15 m²/g to 70 m²/g (e.g., from 29 m²/g to 34 m²/g).

In some examples, the nanostructured electrode can have a photocurrent density of from 0.25 to 10 mA/cm² at a 1 V potential (vs. RHE). In some examples, the nanostructured electrode can have a photocurrent density of 1 mA/cm² or more at a 1 V potential (vs. RHE). In some examples, the nanostructured electrode can have a photocurrent density of 3 mA/cm² or more at a 1 V potential (vs. RHE).

In some examples, the nanostructured electrode can have a photocurrent density of from 0.25 mA/cm² to 10 mA/cm² at a 1.23 V potential (vs. RHE). The nanostructured electrode can, for example, have a photocurrent density of 1.5 mA/cm² or more at a 1.23 V potential (vs. RHE). In some examples, the nanostructured electrode can have a photocurrent density of 4 mA/cm² or more at a 1.23 V potential (vs. RHE).

In some examples, the nanostructured electrode can have a current onset potential of from 0.2 V to 0.31 V vs. RHE. In some examples, the nanostructured electrode can have a current onset potential of 0.26 V vs. RHE or less.

In some examples, the nanostructured electrode can have a solar energy conversion efficiency of from 0.2% to 5% at a 0.8 V potential (vs. RHE). The nanostructured electrode can, for example, have a solar energy conversion efficiency of 0.5% or more at a 0.8 V potential (vs. RHE).

In some examples, the nanostructured electrode can have an incident photon-to-current conversion efficiency (IPCE) of 20% or more (e.g., 30% or more).

Also disclosed herein are methods of making the nanostructured electrodes described herein. For example, also disclosed herein are methods of making a nanostructured electrode comprising depositing a plurality of plasmonic particles on a nanostructured semiconductor, thereby forming the nanostructured electrode. In some examples, the methods can further comprise forming the nanostructured semiconductor. Forming the nanostructured semiconductor can, for example, comprise a hydrothermal reaction, reactive ballistic deposition, atomic layer deposition, pulsed layer deposition, or combinations thereof.

In some examples, forming the nanostructured semiconductor can comprise electrodepositing a first semiconductor precursor on a substrate, thereby forming a nanostructured semiconductor precursor film; contacting the nanostructured semiconductor precursor film with a second semiconductor precursor, thereby forming an impregnated nanostructured semiconductor precursor film; and thermally annealing the impregnated nanostructured semiconductor precursor film, thereby forming the nanostructured semiconductor. The substrate can, for example, comprise a conductive substrate, such as fluorine doped tin oxide (FTO) glass.

Thermally annealing the impregnated nanostructured semiconductor precursor film can, for example, comprise heating the impregnated nanostructured semiconductor precursor film at a temperature of from 400° C. to 500° C. (e.g., 450° C.). The impregnated nanostructured semiconductor precursor film can, for example, be thermally annealed for from 1 hour to 3 hours (e.g. 2 hours).

In some examples, the first semiconductor precursor can comprise BiOl. In some examples, the nanostructured semiconductor precursor film can comprise an array of BiOI nanoflakes. The second semiconductor precursor can, for example, comprise a vanadium compound. In some examples, the nanostructured semiconductor can comprise BiVO4.

Depositing the plurality of plasmonic particles can, for example, comprise printing, lithographic deposition, spin coating, drop-casting, zone casting, dip coating, blade coating, spraying, vacuum filtration, or combinations thereof.

In some examples, depositing the plurality of plasmonic particles can comprise: contacting the nanostructured semiconductor with a plasmonic particle precursor, thereby forming a nanostructured electrode precursor; and thermally annealing the nanostructured electrode precursor to form the nanostructured electrode.

The plasmonic particle precursor can, for example, be contacted with the nanostructured semiconductor for from greater than 0 hours to 24 hours (e.g., from 1 hour to 12 hours). Thermally annealing the nanostructured electrode precursor can, for example, comprise heating the nanostructured electrode precursor at a temperature of from 300° C. to 400° C. (e.g. 350° C.). In some examples, the nanostructured electrode precursor can be thermally annealed for from 0.5 hours to 2 hours (e.g., 1 hour). The plasmonic particle precursor can, for example, comprise a solution comprising a metal salt, such as a gold salt.

Also provided herein are methods of use of the nanostructured electrodes described herein. For example, also provided herein are devices comprising the nanostructured electrodes described herein. Examples of devices comprising the nanostructured electrodes described herein can include sensors, energy conversion devices, or combinations thereof. For example, also provided herein are energy conversion devices comprising the nanostructured electrodes described herein. Examples of energy conversion devices include solar cells, fuel cells, photovoltaic cells, and the like, or combinations thereof.

In some examples, the nanostructured electrodes described herein can be used for solar water oxidation, photocatalytic hydrogen generation, dye removal, water treatment, or combinations thereof.

Also disclosed herein are photoelectrochemical cell comprising: a working electrode comprising the nanostructured electrodes described herein in electrochemical contact with a liquid sample; and one or more additional electrodes in electrochemical contact with the liquid sample. In some examples, the liquid sample comprises water.

Also disclosed herein are methods of use of the photoelectrochemical cells disclosed herein for a water splitting reaction (e.g., solar water splitting). In some examples the water splitting reaction can produce H₂ at a rate of from 30 μmol·h⁻¹·cm⁻² to 80 μmol·h⁻¹·cm⁻² (at 1.0 V vs. RHE). In some examples, the water splitting reaction can produce H₂ at a rate of 60 μmol·h⁻¹·cm⁻² or more. The H2 can be produced, for example with a Faraday efficiency of 90% or more (e.g., 95% or more, 99% or more). In some examples, the water splitting reaction can produce O₂ at a rate of from 15 μmol·h⁻¹·cm⁻² to 40 μmol·h⁻¹·cm⁻² (at 1.0 V vs. RHE). In some examples, the water splitting reaction can produce O₂ at a rate of 30 μmol·h⁻¹·cm⁻² or more. The O₂ can be produced, for example with a Faraday efficiency of 90% or more (e.g., 95% or more, 99% or more).

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE FIGURES

The accompanying figures, which are incorporated in and constitute a part of this specification, illustrate several aspects of the disclosure, and together with the description, serve to explain the principles of the disclosure.

FIG. 1 is a scanning electron micrograph of a BiOI template at low and high magnification (inset).

FIG. 2 is a scanning electron micrograph of BiVO₄ at low magnification and high magnification (inset).

FIG. 3 is a scanning electron micrograph of Au-BiOI at low and high magnification (inset) with an Au loading time of 12 h. A single Au nanoparticle with a diameter of 30 nm is indicated in the inset.

FIG. 4 is a scanning electron micrograph of a BiVO₄ sample loaded with Au nanoparticles (Au—BiVO4), with an Au loading time of 12 hrs.

FIG. 5 is a transmission electron microscopy (TEM) image of an Au—BiVO₄ sample with an Au nanoparticle loading time of 1 hr.

FIG. 6 is a transmission electron microscopy (TEM) image of an Au—BiVO₄ sample with an Au nanoparticle loading time of 3 hrs.

FIG. 7 is a transmission electron microscopy (TEM) image of an Au—BiVO₄ sample with an Au nanoparticle loading time of 6 hrs.

FIG. 8 is a transmission electron microscopy (TEM) image of an Au—BiVO₄ sample with an Au nanoparticle loading time of 12 hrs.

FIG. 9 is a transmission electron microscopy (TEM) image of an Au—BiVO₄ sample with an Au nanoparticle loading time of 24 hrs.

FIG. 10 is a high-resolution transmission electron microscopy (HR-TEM) image of an Au nanoparticle with the Au nanoparticle size distribution shown in the inset.

FIG. 11 is a transmission electron microscopy (TEM) image of an Au—BiVO₄ sample with 24 hours Au nanoparticle loading time, which shows the aggregates from the prolonged Au deposition.

FIG. 12 is a schematic representation of the formation process of the Au nanoparticles.

FIG. 13 is the energy dispersive spectroscopy (EDS) spectrum of an Au—BiVO₄ sample showing the presence of Au.

FIG. 14 is the X-Ray Diffraction (XRD) spectra for pristine BiVO₄ and Au—BiVO₄.

FIG. 15 is the diffuse reflectance spectra of pristine BiVO₄ photoelectrode and Au—BiVO₄ photoelectrodes with the different nanoparticle loading times.

FIG. 16 is the linear-sweep voltammograms of pristine BiVO₄ and Au—BiVO₄ photoelectrodes performed in a 0.2 M aqueous Na₂SO₄ with a pH of 7 under a solar simulator (AM 1.5, 100 mW/cm²). The dark scan is included.

FIG. 17 is the linear-sweep voltammograms of pristine BiVO₄ and Au—BiVO₄ photoelectrodes performed in a 0.2 M aqueous Na₂SO₄ with a pH of 7 under a solar simulator (AM 1.5, 100 mW/cm²) with front-side illumination.

FIG. 18 shows the photocurrent onset potentials of pristine BiVO₄ and different Au nanoparticle loading Au—BiVO₄ photoelectrodes. This is a detailed view of the data in the potential range of −0.40˜−0.28 V (vs. Ag/AgCl) from FIG. 16.

FIG. 19 shows the calculated solar energy conversion efficiencies for the different photoelectrodes. The η was evaluated based on a three-electrode system.

FIG. 20 is the incident photon-to-current conversion efficiency (IPCE) spectra of pristine BiVO₄ and Au—BiVO₄ with Au loading times of 6 hours and 12 hours. The measurements were carried out at an applied potential of +1.0 V vs RHE under a solar simulator (AM 1.5, 100 mW/cm²). The optical absorption spectrum of Au nanoparticles is included.

FIG. 21 is the incident photon-to-current conversion efficiency (IPCE) spectra of pristine BiVO₄ and Au—BiVO₄ with Au loading times of 6 hours and 12 hours. The measurements were carried out at an applied potential of +1.0 V vs RHE under a solar simulator (AM 1.5. 100 mW/cm²) of front-side illumination.

FIG. 22 is the calculated optical scattering spectrum of a single spherical Au nanoparticle with a diameter of 30 nm.

FIG. 23 is the calculated optical absorption spectrum of a single spherical Au nanoparticle with a diameter of 30 nm.

FIG. 24 is an illustration of the plasmon-induced hot-electron injection mechanism.

FIG. 25 shows the incident photon-to-current conversion efficiency (IPCE) enhancement factors for Au—BiVO₄ with Au loading times of 6 hours and 12 hours. Inset is a zoom-in part for the wavelength ranging from 490 nm to 530 nm. Above 530 nm, the factor approaches infinity since there is no photoactivity for pristine BiVO₄ above 530 nm.

FIG. 26 is a plot of photocurrent versus energy of illumination light. The fit with Fowler's theory implies that the majority of photocurrent is attributed to the hot-electron flow.

FIG. 27 shows the amperometric current-time (I-T) curves of Au—BiVO₄ (Au loading time of 12 hours) and pristine BiVO₄ with on/off cycles under illumination of selective light (AM 1.5 and λ>525 nm) at 0.6 V vs RHE. The difference between the activity of pristine BiVO₄ and Au—BiVO₄ is attributed to the plasmonic enhancement. The activity at λ>525 nm reveals the hot-electron injection.

FIG. 28 shows the finite-difference time-domain (FDTD) simulation of the electric field distribution at the interface of a single spherical Au nanoparticle and BiVO₄.

FIG. 29 is a schematic illustration of plasmonic effects in the Au—BiVO₄ photoanodes for solar water splitting

FIG. 30 shows the time courses of H₂ and O₂ evolution for Au—BiVO₄ (12 hours) and BiVO₄ photoelectrodes under AM 1.5G solar simulator in 0.2 M Na₂SO₄ aqueous solution at an applied bias of 1.0 V vs RHE.

FIG. 31 shows the time courses of photocurrent density as a stability test for BiVO₄ photoanodes with different amounts of Au nanoparticles. The measurements are based on AM 1.5G solar simulator at an applied potential of 0.6 V vs RHE.

### DETAILED DESCRIPTION

The nanostructured electrodes described herein may be understood more readily by reference to the following detailed description of specific aspects of the disclosed subject matter and the Examples included therein.

Before the present nanostructured electrodes are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

General Definitions

In this specification and in the claims that follow, reference will be made to a number of terms, which shall be defined to have the following meanings.

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “an agent” includes mixtures of two or more such agents, reference to “the component” includes mixtures of two or more such components, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

Nanostructured Electrodes

Disclosed herein are nanostructured electrodes. As used herein, “nanostructured” means any structure with one or more nanosized features. A nanosized feature can be any feature with at least one dimension less than 1 μm in size. For example, a nanosized feature can comprise a nanowire, nanotube, nanoparticle, nanopore, and the like, or combinations thereof As such, the nanostructured electrode can comprise, for example, a nanowire, nanotube, nanoparticle, nanopore, or a combination thereof. In some examples, the nanostructured electrode can comprise a substrate that is not nanosized by has been modified with a nanowire, nanotube, nanoparticle, nanopore, or a combination thereof.

Nanostructuring can, for example, increase the surface area of a material. The surface area of the nanostructured electrode can be determined, for example, using Brunauer-Emmett-Teller (BET) theory. The nanostructured electrode can, in some examples, have a BET surface area of 15 m²/g or more (e.g., 20 m²/g or more, 21 m²/g or more, 22 m²/g or more, 23 m²/g or more, 24 m²/g or more, 25 m²/g or more, 26 m²/g or more, 27 m²/g or more, 28 m²/g or more, 29 m²/g or more, 29.5 m²/g or more, 30 m²/g or more, 30.5 m²/g or more, 31 m²/g or more, 31.5 m²/g or more, 32 m²/g or more, 32.5 m²/g or more, 33 m²/g or more, 33.5 m²/g or more, 34 m²/g or more, 35 m²/g or more, 36 m²/g or more, 37 m²/g or more, 38 m²/g or more, 39 m²/g or more, 40 m²/g or more, 45 m²/g or more, 50 m²/g or more, 55 m²/g or more, 60 m²/g or more, or 65 m²/g or more). In some examples, the nanostructured electrode can have a BET surface area of 70 m²/g or less (e.g., 65 m²/g or less, 60 m²/g or less, 55 m²/g or less, 50 m²/g or less, 45 m²/g or less, 40 m²/g or less, 39 m²/g or less, 38 m²/g or less, 37 m²/g or less, 36 m²/g or less, 35 m²/g or less, 34 m²/g or less, 33.5 m²/g or less, 33 m²/g or less, 32.5 m²/g or less, 32 m²/g or less, 31.5 m²/g or less, 31 m²/g or less, 30.5 m²/g or less, 30 m²/g or less, 29.5 m²/g or less, 29 m²/g or less, 28 m²/g or less, 27 m²/g or less, 26 m²/g or less, 25 m²/g or less, 24 m²/g or less, 23 m²/g or less, 22 m²/g or less, 21 m²/g or less, or 20 m²/g or less). The BET surface area of the nanostructured electrode can range from any of the minimum values described above to any of the maximum values described above. For example, the nanostructured electrode can have a BET surface area of from 15 m²/g to 70 m²/g (e.g., from 15 m²/g to 40 m²/g, from 40 m²/g to 70 nm, from 15 m²/g to 28 m²/g, from 28 m²/g to 41 m²/g, from 41 m²/g to 54 m²/g, from 54 m²/g to 67 m²/g, from 67 m²/g to 70 m²/g, from 25 m²/g to 50 m²/g, from 29 m²/g to 34 m²/g, or from 30 m²/g to 33 m²/g).

The nanostructured electrodes can, for example, comprise a plurality of plasmonic particles having a plasmon resonance energy in electromagnetic contact with a nanostructured semiconductor having a band gap with a conduction band. The plurality of plasmonic particles can comprise a plasmonic material. Examples of plasmonic materials include, but are not limited to, plasmonic metals (e.g., gold, silver, copper, aluminum, platinum, palladium, or a combination thereof), plasmonic semiconductors (e.g., silicon carbide), doped semiconductors (e.g., aluminum-doped zinc oxide), transparent conducting oxides, perovskites, metal nitrides, silicides, germanides, and two-dimensional plasmonic materials (e.g., graphene), and combinations thereof.

In some examples, the plurality of plasmonic particles can comprise a plurality of metal particles. The plurality of metal particles can, for example, comprise a metal selected from the group consisting of Au, Ag, Pt, Pd, Cu, Al, and combinations thereof. In some examples, the plurality of plasmonic particles can comprise a plurality of gold particles.

The plurality of plasmonic particles can have an average particle size. “Average particle size,” “mean particle size,” and “median particle size” are used interchangeably herein, and generally refer to the statistical mean particle size of the particles in a population of particles. For example, the average particle size for a plurality of particles with a substantially spherical shape can comprise the average diameter of the plurality of particles. For a particle with a substantially spherical shape, the diameter of a particle can refer, for example, to the hydrodynamic diameter. As used herein, the hydrodynamic diameter of a particle can refer to the largest linear distance between two points on the surface of the particle. Mean particle size can be measured using methods known in the art, such as evaluation by scanning electron microscopy, transmission electron microscopy, and/or dynamic light scattering.

The plurality of plasmonic particles can have, for example, an average particle size of 8 nanometers (nm) or more (e.g., 9 nm or more, 10 nm or more, 11 nm or more, 12 nm or more, 13 nm or more, 14 nm or more, 15 nm or more, 16 nm or more, 17 nm or more, 18 nm or more, 19 nm or more, 20 nm or more, 21 nm or more, 22 nm or more, 23 nm or more, 24 nm or more, 25 nm or more, 26 nm or more, 27 nm or more, 28 nm or more, 29 nm or more, 30 nm or more, 31 nm or more, 32 nm or more, 33 nm or more, 34 nm or more, 35 nm or more, 36 nm or more, 37 nm or more, 38 nm or more, 39 nm or more, 40 nm or more, 45 nm or more, 50 nm or more, 55 nm or more, 60 nm or more, 65 nm or more, 70 nm or more, or 75 nm or more). In some examples, the plurality of plasmonic particles can have an average particle size of 80 nm or less (e.g., 75 nm or less, 70 nm or less, 65 nm or less, 60 nm or less, 55 nm or less, 50 nm or less, 45 nm or less, 40 nm or less, 39 nm or less, 38 nm or less, 37 nm or less, 36 nm or less, 35 nm or less, 34 nm or less, 33 nm or less, 32 nm or less, 31 nm or less, 30 nm or less, 29 nm or less, 28 nm or less, 27 nm or less, 26 nm or less, 25 nm or less, 24 nm or less, 23 nm or less, 22 nm or less, 21 nm or less, 20 nm or less, 19 nm or less, 18 nm or less, 17 nm or less, 16 nm or less, 15 nm or less, 14 nm or less, 13 nm or less, 12 nm or less, 11 nm or less, 10 nm or less, or 9 nm or less). The average particle size of the plurality of plasmonic particles can range from any of the minimum values described above to any of the maximum values described above. For example, the plurality of plasmonic particles can have an average particle size of from 8 nm to 40 nm (e.g., from 8 nm to 40 nm, from 4 nm to 80 nm, from 8 nm to 20 nm, from 20 nm to 40 nm, from 40 nm to 60 nm, from 60 nm to 80 nm, from 15 nm to 40 nm, or from 25 nm to 35 nm).

In some examples, the plurality of plasmonic particles can be substantially monodisperse. “Monodisperse” and “homogeneous size distribution,” as used herein, and generally describe a population of particles where all of the particles are the same or nearly the same size. As used herein, a monodisperse distribution refers to particle distributions in which 80% of the distribution (e.g., 85% of the distribution, 90% of the distribution, or 95% of the distribution) lies within 25% of the median particle size (e.g., within 20% of the median particle size, within 15% of the median particle size, within 10% of the median particle size, or within 5% of the median particle size).

The plurality of plasmonic particles can comprise particles of any shape (e.g., a sphere, a rod, a quadrilateral, an ellipse, a triangle, a polygon, etc.). In some examples, the plurality of plasmonic particles can have an isotropic shape. In some examples, the plurality of plasmonic particles can have an anisotropic shape. In some examples, the plurality of plasmonic particles are substantially spherical.

The size, shape, and/or composition of the plurality of plasmonic particles can be selected in view of a variety of factors. In some examples, the size, shape, and/or composition of the plurality of plasmonic particles can be selected to maximize the electromagnetic field enhancement. For example, the size, shape, and/or composition of the plurality of plasmonic particles can be selected such that the intensity of an incident electromagnetic field is enhanced by a factor of 5 or more by the plurality of plasmonic particles (e.g., 10 or more, 20 or more, 30 or more, 40 or more, 50 or more, 60 or more 70 or more, 80 or more, 90 or more, or 100 or more).

In some examples, the size, shape, and/or composition of the plurality of plasmonic particles can be selected to minimize scattering. For example, the size, shape, and/or composition of the plurality of plasmonic particles can be selected such that the ratio of scattering to absorption at a wavelength or wavelength range of interest can be 1:100 or less (e.g., 1:200 or less, 1:300 or less, 1:400 or less, 1:500 or less, 1:600 or less, 1:700 or less, 1:800 or less, 1:900 or less, or 1:1000 or less).

The plurality of plasmonic particles can exhibit localized surface plasmon resonances (LSPRs) which are the coherent oscillations of the free electrons in the plurality of plasmonic particles stimulated by incident electromagnetic radiation (e.g., light). The resonance condition is established when the frequency of the incident electromagnetic radiation matches the natural frequency of surface electrons oscillating against the restoring forces of positive nuclei in the plurality of plasmonic particles. As the relationships between frequency, wavelength, and energy are well established for electromagnetic radiation, the localized surface plasmon resonances can be described in terms of any of these values. As such, the plasmon resonance energy of the plurality of particles can be described according to the wavelength (or range of wavelengths) of electromagnetic radiation (e.g., light) that can establish the resonance condition.

In some examples, the plasmon resonance energy of the plurality of particles can correspond to a plasmon resonant wavelength from 200 nm to 3000 nm (e.g., from 200 nm to 1500 nm, from 1500 nm to 3000 nm, from 200 nm to 400 nm, from 400 nm to 600 nm, from 600 nm to 800 nm, from 800 nm to 1000 nm, from 1000 nm to 1200 nm, from 1200 nm to 1400 nm, from 1400 nm to 1600 nm, from 1600 nm to 1800 nm, from 1800 nm to 2000 nm, from 2000 nm to 2200 nm, from 2200 nm to 2400 nm, from 2400 nm to 2600 nm to 2800 nm, or from 2800 nm to 3000 nm).

The nanostructured semiconductor can comprise any semiconductor any semiconductor material with an appropriate band gap energy. In some examples, the nanostructured semiconductor can comprise a metal oxide, a metal sulfide, a metal selenide, a metal nitride, or combinations thereof. For example, the nanostructured semiconductor can comprise Fe₂O₃, WO₃, Ta₃N₅, TaON, TiO₂, ZnO, CdS, CdSe, BiVO₄, or combinations thereof.

In some examples, the nanostructured semiconductor can comprise a metal oxide. The metal oxide can, in some examples, comprise a mixed metal oxide (e.g., with different metal elements). The metal oxide can, for example, comprise a metal selected from the group consisting of Be, Mg, Al, Ca, Sc, Ti, V, Cr, Mn, Fe, Co, Ni, Cu, Zn, Ga, Sr, Y, Zr, Nb, Mo, Tc, Ru, Rh, Pd, Ag, Cd, In, Sn, Ba, Hf, Ta, W, Re, Os, Ir, Pt, Au, Hg, Tl, Pb, Bi, La, Ce, Pr, Nd, Pm, Sm, Eu, Gd, Tb, Dy, Ho, Er, Tm, Yb, and combinations thereof. In some examples, the nanostructured semiconductor comprises BiVO₄.

In some examples, the nanostructured semiconductor can comprise a metal sulfide. The metal sulfide can, for example, comprise a metal selected from the group consisting of Be, Mg, Al, Ca, Sc, Ti, V, Cr, Mn, Fe, Co, Ni, Cu, Zn, Ga, Sr, Y, Zr, Nb, Mo, Tc, Ru, Rh, Pd, Ag, Cd, In, Sn, Ba, Hf, Ta, W, Re, Os, Ir, Pt, Au, Hg, Tl, Pb, Bi, La, Ce, Pr, Nd, Pm, Sm, Eu, Gd, Tb, Dy, Ho, Er, Tm, Yb, and combinations thereof.

In some examples, the nanostructured semiconductor can comprise a metal selenide. The metal selenide can, for example, comprise a metal selected from the group consisting of Be, Mg, Al, Ca, Sc, Ti, V, Cr, Mn, Fe, Co, Ni, Cu, Zn, Ga, Sr, Y, Zr, Nb, Mo, Tc, Ru, Rh, Pd, Ag, Cd, In, Sn, Ba, Hf, Ta, W, Re, Os, Ir, Pt, Au, Hg, Tl, Pb, Bi, La, Ce, Pr, Nd, Pm, Sm, Eu, Gd, Tb, Dy, Ho, Er, Tm, Yb, and combinations thereof.

In some examples, the nanostructured semiconductor can comprise a metal nitride. The metal nitride can, for example, comprise a metal selected from the group consisting of Be, Mg, Al, Ca, Sc, Ti, V, Cr, Mn, Fe, Co, Ni, Cu, Zn, Ga, Sr, Y, Zr, Nb, Mo, Tc, Ru, Rh, Pd, Ag, Cd, In, Sn, Ba, Hf, Ta, W, Re, Os, Ir, Pt, Au, Hg, Tl, Pb, Bi, La, Ce, Pr, Nd, Pm, Sm, Eu, Gd, Tb, Dy, Ho, Er, Tm, Yb, and combinations thereof.

The nanostructured semiconductor can, for example, comprise a continuous semiconductor phase comprising a plurality of semiconductor particles. “Phase,” as used herein, generally refers to a region of a material having a substantially uniform composition which is a distinct and physically separate portion of a heterogeneous system. The term “phase” does not imply that the material making up a phase is a chemically pure substance, but merely that the chemical and/or physical properties of the material making up the phase are essentially uniform throughout the material, and that these chemical and/or physical properties differ significantly from the chemical and/or physical properties of another phase within the material. Examples of physical properties include density, thickness, aspect ratio, specific surface area, porosity and dimensionality. Examples of chemical properties include chemical composition.

“Continuous,” as used herein, generally refers to a phase such that all points within the phase are directly connected, so that for any two points within a continuous phase, there exists a path which connects the two points without leaving the phase.

The plurality of semiconductor particles can, for example, have an average particle size of 20 nm or more (e.g., 25 nm or more, 30 nm or more, 35 nm or more, 40 nm or more, 45 nm or more, 50 nm or more, 55 nm or more, 60 nm or more, 65 nm or more, 70 nm or more, 75 nm or more, 80 nm or more, 85 nm or more, 90 nm or more, 95 nm or more, 100 nm or more, 105 nm or more, 110 nm or more, or 115 nm or more). In some examples, the plurality of semiconductor particles can have an average size of 120 nm or less (e.g., 115 nm or less, 110 nm or less, 105 nm or less, 100 nm or less, 95 nm or less, 90 nm or less, 85 nm or less, 80 nm or less, 75 nm or less, 70 nm or less, 65 nm or less, 60 nm or less, 55 nm or less, 50 nm or less, 45 nm or less, 40 nm or less, 35 nm or less, 30 nm or less, or 25 nm or less). The average particle size of the plurality of semiconductor particles can range from any of the minimum values described above to any of the maximum values described above. For example, the plurality of semiconductor particles can have an average particle size of from 20 nm to 120 nm (e.g., from 20 nm to 70 nm, from 70 nm to 120 nm, from 20 nm to 40 nm, from 40 nm to 60 nm, from 60 nm to 80 nm, from 80 nm to 100 nm, from 100 nm to 120 nm, from 40 nm to 100 nm, from 60 nm to 80 nm, or from 65 nm to 75 nm). In some examples, the plurality of semiconductor particles can be substantially monodisperse.

The plurality of semiconductor particles can comprise particles of any shape (e.g., a sphere, a rod, a quadrilateral, an ellipse, a triangle, a polygon, etc.). In some examples, the plurality of semiconductor particles are substantially spherical in shape.

The size, shape, and/or composition of the plurality of semiconductor particles can be selected in view of a variety of factors. In some examples, the size of the plurality of semiconductor particles can be selected such that the average particle size of the plurality of semiconductor particles is smaller than the hole diffusion length.

In some examples, the nanostructured semiconductor can have a band gap energy of 2.3 eV or more (e.g., 2.31 eV or more, 2.32 eV or more, 2.33 eV or more, 2.34 eV or more, 2.35 eV or more, 2.36 eV or more, 2.37 eV or more, 2.38 eV or more, 2.39 eV or more, 2.4 eV or more, 2.41 eV or more, 2.42 eV or more, 2.43 eV or more, 2.44 eV or more, 2.45 eV or more, 2.46 eV or more, 2.47 eV or more, 2.48 eV or more, or 2.49 eV or more). In some examples, the nanostructured semiconductor can have a band gap energy of 2.5 eV or less (e.g., 2.49 eV or less, 2.48 eV or less, 2.47 eV or less, 2.46 eV or less, 2.45 eV or less, 2.44 eV or less, 2.43 eV or less, 2.42 eV or less, 2.41 eV or less, 2.4 eV or less, 2.39 eV or less, 2.38 eV or less, 2.37 eV or less, 2.36 eV or less, 2.35 eV or less, 2.34 eV or less, 2.33 eV or less, 2.32 eV or less, or 2.31 eV or less). The band gap energy of the nanostructured semiconductor can range from any of the minimum values described above to any of the maximum values described above. For example, the nanostructured semiconductor can have a band gap energy of from 2.3 eV to 2.5 eV (e.g., from 2.3 eV to 2.4 eV, from 2.4 eV to 2.5 eV, from 2.3 eV to 2.35 eV, from 2.35 eV to 2.4 eV, from 2.4 eV to 2.45 eV, from 2.45 eV to 2.5 eV, from 2.35 eV to 2.45 eV, or from 2.37 eV to 2.42 eV).

In some examples, at least a portion of the plasmon resonance energy of the plurality of plasmonic particles is higher in energy than the conduction band of the nanostructured semiconductor. In certain examples, upon decay of the localized surface plasmon resonance of the plurality of plasmonic particles, hot electrons can be injected from the plurality of plasmonic particles into the conduction band of the nanostructured semiconductor.

In some examples, the plasmon resonance energy of the plurality of plasmonic particles can at least partially overlap with the band gap of the nanostructured semiconductor. In certain examples, overlap between the band gap of the nanostructured semiconductor and the plasmon resonance energy of the plurality of plasmonic nanoparticles can allow for plasmon resonance energy transfer from the plurality of plasmonic nanoparticles to the nanostructured semiconductor.

The nanostructured electrode can, for example, have a higher photocurrent density compared to the bare nanostructured semiconductor (e.g., without the plurality of plasmonic particles). In some examples, the nanostructured electrode can have a photocurrent density of 0.25 mA/cm² or more at a 1 V potential (vs. RHE) (e.g., 0.5 mA/cm² or more, 1 mA/cm² or more, 1.5 mA/cm² or more, 2 mA/cm² or more, 2.5 mA/cm² or more, 3 mA/cm² or more, 3.5 mA/cm² or more, 4 mA/cm² or more, 4.5 mA/cm² or more, 5 mA/cm² or more, 5.5 mA/cm² or more, 6 mA/cm² or more, 6.5 mA/cm² or more, 7 mA/cm² or more, 7.5 mA/cm² or more, 8 mA/cm² or more, 8.5 mA/cm² or more, 9 mA/cm² or more, or 9.5 mA/cm² or more). In some examples, the nanostructured electrode can have a photocurrent density of 10 mA/cm² or less at a 1 V potential (vs. RHE) (e.g., 9.5 mA/cm² or less, 9 mA/cm² or less, 8.5 mA/cm² or less, 8 mA/cm² or less, 7.5 mA/cm² or less, 7 mA/cm² or less, 6.5 mA/cm² or less, 6 mA/cm² or less, 5.5 mA/cm² or less, 5 mA/cm² or less, 4.5 mA/cm² or less, 4 mA/cm² or less, 3.5 mA/cm² or less, 3 mA/cm² or less, 2.5 mA/cm² or less, 2 mA/cm² or less, 1.5 mA/cm² or less, 1 mA/cm² or less, or 0.5 mA/cm² or less). The photocurrent of the nanostructured electrode at a 1 V potential (vs. RHE) can range from any of the minimum values described above to any of the maximum values described above. For example, the nanostructured electrode can have a photocurrent density of from 0.25 mA/cm² to 10 mA/cm² at a 1 V potential (vs. RHE) (e.g., from 0.25 mA/cm² to 5 mA/cm², from 5 mA/cm² to 10 mA/cm², from 0.25 mA/cm² to 2.5 mA/cm², from 2.5 mA/cm² to 5 mA/cm², from 5 mA/cm² to 7.5 mA/cm², from 7.5 mA/cm² to 10 mA/cm², from 1 mA/cm² to 9 mA/cm², or from 3 mA/cm² to 6 mA/cm²).

In some examples, the nanostructured electrode can have a photocurrent density of 0.25 mA/cm² or more at a 1.23 V potential (vs. RHE) (e.g., 0.5 mA/cm² or more, 1 mA/cm² or more, 1.5 mA/cm² or more, 2 mA/cm² or more, 2.5 mA/cm² or more, 3 mA/cm² or more, 3.5 mA/cm² or more, 4 mA/cm² or more, 4.5 mA/cm² or more, 5 mA/cm² or more, 5.5 mA/cm² or more, 6 mA/cm² or more, 6.5 mA/cm² or more, 7 mA/cm² or more, 7.5 mA/cm² or more, 8 mA/cm² or more, 8.5 mA/cm² or more, 9 mA/cm² or more, or 9.5 mA/cm² or more). In some examples, the nanostructured electrode can have a photocurrent density of 10 mA/cm² or less at a 1.23 V potential (vs. RHE) (e.g., 9.5 mA/cm² or less, 9 mA/cm² or less, 8.5 mA/cm² or less, 8 mA/cm² or less, 7.5 mA/cm² or less, 7 mA/cm² or less, 6.5 mA/cm² or less, 6 mA/cm² or less, 5.5 mA/cm² or less, 5 mA/cm² or less, 4.5 mA/cm² or less, 4 mA/cm² or less, 3.5 mA/cm² or less, 3 mA/cm² or less, 2.5 mA/cm² or less, 2 mA/cm² or less, 1.5 mA/cm² or less, 1 mA/cm² or less, or 0.5 mA/cm² or less). The photocurrent of the nanostructured electrode at a 1.23 V potential (vs. RHE) can range from any of the minimum values described above to any of the maximum values described above. For example, the nanostructured electrode can have a photocurrent density of from 0.25 mA/cm² to 10 mA/cm² at a 1.23 V potential (vs. RHE) (e.g., from 0.25 mA/cm² to 5 mA/cm², from 5 mA/cm² to 10 mA/cm², from 0.25 mA/cm² to 2.5 mA/cm², from 2.5 mA/cm² to 5 mA/cm², from 5 mA/cm² to 7.5 mA/cm², from 7.5 mA/cm² to 10 mA/cm², from 1.5 mA/cm² to 9 mA/cm², or from 4 mA/cm² to 6 mA/cm²).

The photocurrent density of the nanostructured electrode can be stable long-term. For example, the photocurrent density of the nanostructured electrode can decay by 5% or less (e.g., 4% or less, 3% or less, 2% or less, or 1% or less) when a potential is applied for 100 minutes or more (e.g., 120 minutes or more, 140 minutes or more, 160 minutes or more, 180 minutes or more, or 200 minutes or more).

The current onset potential of the nanostructured electrode can, for example, be shifted cathodically compared to the current onset potential of the bare nanostructured semiconductor (e.g., without the plurality of plasmonic particles). In some examples, the nanostructured electrode can have a current onset potential of 0.31 V or less vs. RHE (e.g., 0.305 V or less, 0.3 V or less, 0.295 V or less, 0.29 V or less, 0.285 V or less, 0.28 V or less, 0.275 V or less, 0.27 V or less, 0.265 V or less, 0.26 V or less, 0.255 V or less, 0.25 V or less, 0.245 V or less, 0.24 V or less, 0.235 V or less, 0.23 V or less, 0.225 V or less, 0.22 V or less, 0.215 V or less, 0.21 V or less, or 0.205 V or less). In some examples, the nanostructured electrode can have a current onset potential of 0.2 V or more vs. RHE (e.g., 0.205 V or more, 0.21 V or more, 0.215 V or more, 0.22 V or more, 0.225 V or more, 0.23 V or more, 0.235 V or more, 0.24 V or more, 0.245 V or more, 0.25 V or more, 0.255 V or more, 0.26 V or more, 0.265 V or more, 0.27 V or more, 0.275 V or more, 0.28 V or more, 0.285 V or more, 0.29 V or more, 0.295 V or more, 0.3 V or more, or 0.305 V or more). The current onset potential (vs. RHE) of the nanostructured electrode can range from any of the minimum values described above to any of the maximum values described above. For example, the nanostructured electrode can have a current onset potential of from 0.2 V to 0.31 V vs. RHE (e.g., from 0.2 V to 0.26 V, from 0.26 V to 0.31 V, from 0.2 V to 0.23 V, from 0.23 V to 0.26 V, from 0.26 V to 0.29 V, from 0.29 V to 0.31 V, or from 0.22 V to 0.29 V).

The nanostructured electrode can, for example, have a higher solar energy conversion efficiency than the bare nanostructured semiconductor (e.g., without the plurality of plasmonic particles). In some examples, the nanostructured electrode can have a solar energy conversion efficiency of 0.2% or more at a 0.8 V potential (vs. RHE) (e.g., 0.3% or more, 0.4% or more, 0.5% or more, 0.6% or more, 0.7% or more, 0.8% or more, 0.9% or more, 1% or more, 1.1% or more, 1.2% or more, 1.3% or more, 1.4% or more, 1.5% or more, 1.6% or more, 1.7% or more, 1.8% or more, 1.9% or more, 2% or more, 2.5% or more, 3% or more, 3.5% or more, 4% or more, or 4.5% or more). In some examples, the nanostructured electrode can have a solar energy conversion efficiency of 5% or less at a 0.8 V potential (vs. RHE) (e.g., 4.5% or less, 4% or less, 3.5% or less, 3% or less, 2.5% or less, 2% or less, 1.9% or less, 1.8% or less, 1.7% or less, 1.6% or less, 1.5% or less, 1.4% or less, 1.3% or less, 1.2% or less, 1.1% or less, 1% or less, 0.9% or less, 0.8% or less, 0.7% or less, 0.6% or less, 0.5% or less, 0.4% or less, or 0.3% or less). The solar conversion efficiency of the nanostructured electrode can range from any of the minimum values described above to any of the maximum values described above. For example, the nanostructured electrode can have a solar conversion efficiency of from 0.2% to 5% at a 0.8 V potential (vs. RHE) (e.g., from 0.2% to 2.5%, from 2.5% to 5%, from 0.2% to 1%, from 1% to 2%, from 2% to 3%, from 3% to 4%, from 4% to 5%, or from 0.5% to 4.5%).

The incident photon-to-current conversion efficiency (IPCE) can, for example, be used to quantitatively investigate the relations between the photoactivity and the light absorption of the nanostructured electrodes. The nanostructured electrodes can, in some examples, have a higher incident photon-to-current conversion efficiency than the bare nanostructured semiconductor (e.g., without the plurality of plasmonic particles). In some examples, the incident photo-to-current conversion efficiency of the nanostructured electrode can be 4 or more times higher than the incident photo-to-current conversion efficiency of the bare nanostructured semiconductor (e.g., 5 or more, 10 or more, 15 or more, 20 or more, 25 or more, 30 or more, 35 or more, 40 or more, 45 or more, 50 or more, 60 or more, 70 or more, 80 or more, 90 or more, or 100 or more).

In some examples, the nanostructured electrode can have an incident photon-to-current conversion efficiency (IPCE) of 20% or more (e.g., 21% or more, 22% or more, 23% or more, 24% or more, 25% or more, 26% or more, 27% or more, 28% or more, 29% or more, 30% or more, 31% or more, 32% or more, 33% or more, 34% or more, 35% or more, 36% or more, 37% or more, 38% or more, 39% or more, 40% or more, 41% or more, 42% or more, 43% or more, 44% or more, 45% or more, 46% or more, 47% or more, 48% or more, 49% or more, 50% or more, 55% or more, 60% or more, 65% or more, 70% or more, 75% or more, 80% or more, 85% or more, 90% or more, or 95% or more).

Methods of Making

Also disclosed herein are methods of making the nanostructured electrodes described herein. For example, also disclosed herein are methods of making a nanostructured electrode comprising depositing a plurality of plasmonic particles on a nanostructured semiconductor, thereby forming the nanostructured electrode.

In some examples, the methods can further comprise forming the nanostructured semiconductor. Forming the nanostructured semiconductor can, for example, comprise a hydrothermal reaction, reactive ballistic deposition, atomic layer deposition, pulsed layer deposition, or combinations thereof.

In some examples, forming the nanostructured semiconductor can comprise electrodepositing a first semiconductor precursor on a substrate, thereby forming a nanostructured semiconductor precursor film; contacting the nanostructured semiconductor precursor film with a second semiconductor precursor, thereby forming an impregnated nanostructured semiconductor precursor film; and thermally annealing the impregnated nanostructured semiconductor precursor film, thereby forming the nanostructured semiconductor. The substrate can, for example, comprise a conductive substrate. Examples of conductive substrates include conducting metal oxides (e.g., CdO, CdIn₂O₄, Cd2SnO₄, Cr₂O₃, CuCrO₂, CuO₂, Ga₂O₃, In₂O₃, NiO, SnO₂, TiO₂, ZnGa₂O₄, ZnO, and combinations thereof, any of which can further comprise one or more dopants), conducting polymers (e.g., polyacetylene, polyaniline, polypyrrole, polythiophene, derivatives thereof, or combinations thereof), graphitic conducting substrates (e.g., carbon nanotubes, graphene), or combinations thereof. In some examples, the substrate can comprise fluorine doped tin oxide (FTO) glass.

Thermally annealing the impregnated nanostructured semiconductor precursor film can, for example, comprise heating the impregnated nanostructured semiconductor precursor film at a temperature of 400° C. or more (e.g., 410° C. or more, 420° C. or more, 430° C. or more, 440° C. or more, 450° C. or more, 460° C. or more, 470° C. or more, 480° C. or more, or 490° C. or more). In some examples, thermally annealing the impregnated nanostructured semiconductor precursor film can comprise heating the impregnated nanostructured semiconductor precursor film at a temperature of 500° C. or less (e.g., 490° C. or less, 480° C. or less, 470° C. or less, 460° C. or less, 450° C. or less, 440° C. or less, 430° C. or less, 420° C. or less, or 410° C. or less). The temperature at which the impregnated nanostructured semiconductor precursor is thermally annealed can range from any of the minimum values described above to any of the maximum values described above. For example, thermally annealing the impregnated nanostructured semiconductor precursor film can comprise heating the impregnated nanostructured semiconductor precursor film at a temperature of from 400° C. to 500° C. (e.g., from 400° C. to 450° C., from 450° C. to 500° C., from 400° C. to 420° C., from 420° C. to 440° C., from 440° C. to 460° C., from 460° C. to 480° C., from 480° C. to 500° C., from 410° C. to 490° C., or from 420° C. to 480° C.), In some examples, thermally annealing the impregnated nanostructured semiconductor precursor film can comprise heating the impregnated nanostructured semiconductor precursor film at a temperature of 450° C.

The impregnated nanostructured semiconductor precursor film can, for example, be thermally annealed for 1 hour or more (e.g., 1.25 hours or more, 1.5 hours or more, 1.75 hours or more, 2 hours or more, 2.25 hours or more, 2.5 hours or more, or 2.75 hours or more). In some examples, the impregnated nanostructured semiconductor precursor film can be thermally annealed for 3 hours or less (e.g., 2.75 hours or less, 2.5 hours or less, 2.25 hours or less, 2 hours or less, 1.75 hours or less, 1.5 hours or less, or 1.25 hours or less). The time for which the impregnated nanostructured semiconductor precursor film is thermally annealed can range from any of the minimum values described above to any of the maximum values described above. For example, impregnated nanostructured semiconductor precursor film can be thermally annealed for from 1 hour to 3 hours (e.g., from 1 hour to 2 hours, from 2 hours to 3 hours, from 1 hour to 1.5 hours, from 1.5 hours to 2 hours, from 2 hours to 2.5 hours, from 2.5 hours to 3 hours, from 1.5 hours to 2.5 hours, or from 1.75 hours to 2.25 hours). In some examples, impregnated nanostructured semiconductor precursor film can be thermally annealed for 2 hours.

In some examples, the first semiconductor precursor can comprise BiOl. In some examples, the nanostructured semiconductor precursor film can comprise an array of BiOI nanoflakes. The second semiconductor precursor can, for example, comprise a vanadium compound. In some examples, the nanostructured semiconductor can comprise BiVO₄.

Depositing the plurality of plasmonic particles can, for example, comprise printing, lithographic deposition, spin coating, drop-casting, zone casting, dip coating, blade coating, spraying, vacuum filtration, or combinations thereof.

In some examples, depositing the plurality of plasmonic particles can comprise: contacting the nanostructured semiconductor with a plasmonic particle precursor, thereby forming a nanostructured electrode precursor; and thermally annealing the nanostructured electrode precursor to form the nanostructured electrode.

The plasmonic particle precursor can, for example, be contacted with the nanostructured semiconductor for greater than 0 hours (e.g., 1 hour or more, 2 hours or more, 3 hours or more, 4 hours or more, 5 hours or more, 6 hours or more, 7 hours or more, 8 hours or more, 9 hours or more, 10 hours or more, 11 hours or more, 12 hours or more, 13 hours or more, 14 hours or more, 15 hours or more, 16 hours or more, 17 hours or more, 18 hours or more, 19 hours or more, 20 hours or more, 21 hours or more, 22 hours or more, or 23 hours or more). In some examples, the plasmonic particle precursor can be contacted with the nanostructured semiconductor for 24 hours or less (e.g., 23 hours or less, 22 hours or less, 21 hours or less, 20 hours or less, 19 hours or less, 18 hours or less, 17 hours or less, 16 hours or less, 15 hours or less, 14 hours or less, 13 hours or less, 12 hours or less, 11 hours or less, 10 hours or less, 9 hours or less, 8 hours or less, 7 hours or less, 6 hours or less, 5 hours or less, 4 hours or less, 3 hours or less, 2 hours or less, or 1 hour or less).

The amount of time that the nanostructured semiconductor can be contacted with the plasmonic particle precursor can range from any of the minimum values described above to any of the maximum values described above. For example, he plasmonic particle precursor can be contacted with the nanostructured semiconductor for from greater than 0 hours to 24 hours (e.g., from greater than 0 hours to 6 hours, from 6 hours to 12 hours, from 12 hours to 18 hours, from 18 hours to 24 hours, or from 1 hour to 12 hours).

Thermally annealing the nanostructured electrode precursor can, for example, comprise heating the nanostructured electrode precursor at a temperature of 300° C. or more (e.g., 310° C. or more, 320° C. or more, 330° C. or more, 340° C. or more, 350° C. or more, 360° C. or more, 370° C. or more, 380° C. or more, or 390° C. or more). In some examples, thermally annealing the nanostructured electrode precursor can comprise heating the nanostructured electrode precursor at a temperature of 400° C. or less (e.g., 390° C. or less, 380° C. or less, 370° C. or less, 360° C. or less, 350° C. or less, 340° C. or less, 330° C. or less, 320° C. or less, or 310° C. or less). The temperature at which the nanostructured electrode precursor is thermally annealed can range from any of the minimum values described above to any of the maximum values described above. For example, thermally annealing the nanostructured electrode precursor can comprise heating the nanostructured electrode precursor at a temperature of from 300° C. to 400° C. (e.g., from 300° C. to 350° C., from 250° C. to 400° C., from 300° C. to 320° C., from 320° C. to 340° C., from 340° C. to 360° C., from 360° C. to 380° C., from 380° C. to 400° C., from 320° C. to 380° C., or from 330° C. to 370° C.). In some examples, thermally annealing the nanostructured electrode precursor can comprise heating the nanostructured electrode precursor at a temperature of 350° C.

In some examples, the nanostructured electrode precursor can be thermally annealed for 0.5 hours or more (e.g., 0.6 hours or more, 0.7 hours or more, 0.8 hours or more, 0.9 hours or more, 1 hour or more, 1.1 hours or more, 1.2 hours or more, 1.3 hours or more, 1.4 hours or more, 1.5 hours or more, 1.6 hours or more, 1.7 hours or more, 1.8 hours or more, or 1.9 hours or more). In some examples, the nanostructured electrode precursor can be thermally annealed for 2 hours or less (e.g., 1.9 hours or less, 1.8 hours or less, 1.7 hours or less, 1.6 hours or less, 1.5 hours or less, 1.4 hours or less, 1.3 hours or less, 1.2 hours or less, 1.1 hours or less, 1 hour or less, 0.9 hours or less, 0.8 hours or less, 0.7 hours or less, or 0.6 hours or less). The amount of time for which the nanostructured electrode precursor is thermally annealed can range from any of the minimum values described above to any of the maximum values described above. For example, the nanostructured electrode precursor can be thermally annealed for from 0.5 hours to 2 hours (e.g., from 0.5 hours to 1.2 hours, from 1.2 hours to 2 hours, from 0.5 hours to 1 hour, from 1 hour to 1.5 hours, from 1.5 hours to 2 hours, from 0.5 hours to 1.5 hours, from 0.7 hours to 1.3 hours, or from 0.8 hours to 1.2 hours). In some examples, the nanostructured electrode precursor can be thermally annealed for 1 hour.

The plasmonic particle precursor can, for example, comprise a solution comprising a metal salt, such as a gold salt.

Methods of Use

Also provided herein are methods of use of the nanostructured electrodes described herein. For example, the nanostructured electrodes described herein can be used in various articles of manufacture including sensors (e.g., biosensors), electronic devices, optical devices, and energy conversion devices. For example, also provided herein are energy conversion devices comprising the nanostructured electrodes described herein. Examples of energy conversion devices include solar cells, fuel cells, photovoltaic cells, and the like, or combinations thereof. Such devices can be fabricated by methods known in the art.

In some examples, the nanostructured electrodes described herein can be used for solar water oxidation, photocatalytic hydrogen generation, dye removal, water treatment, or combinations thereof.

Also disclosed herein are photoelectrochemical cell comprising: a working electrode comprising the nanostructured electrodes described herein in electrochemical contact with a liquid sample; and one or more additional electrodes in electrochemical contact with the liquid sample. In some examples, the liquid sample comprises water.

Also disclosed herein are methods of use of the photoelectrochemical cells disclosed herein for a water splitting reaction (e.g., solar water splitting). In some examples, the water splitting reaction can produce H₂ at a rate of 30 μmol·h⁻¹·cm² or more (at 1.0 V vs. RHE) (e.g., 35 μmol·h⁻¹·cm⁻² or more, 40 μmol·h⁻¹·cm⁻² or more, 45 μmol·h⁻¹·cm⁻² or more, 50 μmol·h⁻¹·cm⁻² or more, 55 μmol·h⁻¹·cm⁻² or more, 60 μmol·h⁻¹·cm⁻² or more, 65 μmol·h⁻¹·cm⁻² or more, 70 μmol·h⁻¹·cm⁻² or more, or 75 μmol·h⁻¹·cm⁻² or more). In some examples, the water splitting reaction can produce H₂ at a rate of 80 μmol·h⁻¹·cm⁻² or less (at 1.0 V vs. RHE) (e.g., 75 μmol·h⁻¹·cm⁻² or less, 70 μmol·h⁻¹·cm⁻² or less, 65 μmol·h⁻¹·cm⁻² or less, 60 μmol·h⁻¹·cm⁻² or less, 55 μmol·h⁻¹·cm⁻² or less, 50 μmol·h⁻¹·cm⁻² or less, 45 μmol·h⁻¹·cm⁻² or less, 40 μmol·h⁻¹·cm⁻² or less, or 35 μmol·h⁻¹·cm⁻² or less). The rate at which H₂ is produced in the water splitting reaction can range from any of the minimum values described above to any of the maximum values described above. For example the water splitting reaction can produce H₂ at a rate of from 30 μmol·h⁻¹·cm⁻² to 80 μmol·h⁻¹·cm⁻² (at 1.0 V vs. RHE) (e.g., from 30 μmol·h⁻¹·cm⁻² to 55 μmol·h⁻¹·cm⁻², from 55 μmol·h⁻¹·cm⁻² to 80 μmol·h⁻¹·cm⁻², from 30 μmol·h⁻¹·cm⁻² to 40 μmol·h⁻¹·cm⁻², from 40 μmol·h⁻¹·cm⁻² to 50 μmol·h⁻¹·cm⁻², from 50 μmol·h⁻¹·cm⁻² to 60 μmol·h⁻¹·cm⁻², from 60 μmol·h⁻¹·cm⁻² to 70 μmol·h⁻¹·cm⁻², from 70 μmol·h⁻¹·cm⁻² to 80 μmol·h⁻¹·cm⁻², or from 30 μmol·h⁻¹·cm² to 70 μmol·h⁻¹·cm⁻²).

The H₂ can be produced, for example with a Faraday efficiency of 90% or more (e.g., 91% or more, 92% or more, 93% or more, 94% or more, 95% or more, 96% or more, 97% or more, 98% or more, or 99% or more). In some examples, the H₂ can be produced with a Faraday efficiency of 99% or more (e.g., 99.1% or more, 99.2% or more, 99.3% or more, 99.4% or more, 99.5% or more, 99.6% or more, 99.7% or more, 99.8% or more, or 99.9% or more).

In some examples, the water splitting reaction can produce O₂ at a rate of 15 μmol·h⁻¹·cm⁻² or more (at 1.0 V vs. RHE) (e.g., 20 μmol·h⁻¹·cm⁻² or more, 25 μmol·h⁻¹·cm⁻² or more, 30 μmol·h⁻¹·cm⁻² or more, or 35 μmol·h⁻¹·cm⁻² or more). In some examples, the water splitting reaction can produce O₂ at a rate of 40 μmol·h⁻¹·cm⁻² or less (at 1.0 V vs. RHE) (e.g., 35 μmol·h⁻¹·cm⁻² or less, 30 μmol·h⁻¹·cm⁻² or less, 25 μmol·h⁻¹·cm⁻² or less, or 20 μmol·h⁻¹·cm⁻² or less). The rate at which O₂ is produced in the water splitting reaction can range from any of the minimum values described above to any of the maximum values described above. For example, the water splitting reaction can produce O₂ at a rate of from 15 μmol·h⁻¹·cm⁻² to 40 μmol·h⁻¹·cm⁻² (at 1.0 V vs. RHE) (e.g., from 15 μmol·h⁻¹·cm⁻² to 25 μmol·h⁻¹·cm⁻², from 25 μmol·h⁻¹·cm⁻² to 40 μmol·h⁻¹·cm⁻², from 15 μmol·h⁻¹·cm⁻² to 20 μmol·h⁻¹·cm⁻², from 20 μmol·h⁻¹·cm⁻² to 25 μmol·h⁻¹·cm⁻², from 25 μmol·h⁻¹·cm⁻² to 30 μmol·h⁻¹·cm⁻², from 30 μmol·h⁻¹·cm⁻² to 35 μmol·h⁻¹·cm⁻², from 35 μmol·h⁻¹·cm⁻² to 40 μmol·h⁻¹·cm⁻², or from 15 μmol·h⁻¹·cm⁻² to 35 μmol·h⁻¹·cm⁻²).

The O₂ can be produced, for example with a Faraday efficiency of 90% or more (e.g., 91% or more, 92% or more, 93% or more, 94% or more, 95% or more, 96% or more, 97% or more, 98% or more, or 99% or more). In some examples, the O₂ can be produced with a Faraday efficiency of 99% or more (e.g., 99.1% or more, 99.2% or more, 99.3% or more, 99.4% or more, 99.5% or more, 99.6% or more, 99.7% or more, 99.8% or more, or 99.9% or more).

A number of embodiments of the invention have been described. Nevertheless, it will be understood that various modifications may be made without departing from the spirit and scope of the invention. Accordingly, other embodiments are within the scope of the following claims.

The examples below are intended to further illustrate certain aspects of the systems and methods described herein, and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of measurement conditions, e.g., component concentrations, temperatures, pressures and other measurement ranges and conditions that can be used to optimize the described process.

### Example 1

Conversion of solar irradiation into chemical fuels such as hydrogen with the use of a photoelectrochemical (PEC) cell is an attractive strategy for green energy. However, the photoelectrochemical cells have performed very poorly in comparison to the theoretical expectations. Following the initial demonstration of PEC cell comprising a single-crystalline TiO₂ anode and a Pt cathode (Fujishima A and Honda K. Nature, 1972, 238, 37), researches have made significant progress in developing new electrode materials to improve the power conversion efficiency.

Metal oxides such as hematite (α-Fe₂O₃) (Shen S et al. Nano Energy 2012, 1, 732; Liu J et al. Nano Energy 2013, 2, 328), zinc oxide (ZnO) (Yang X et al. Nano Lett. 2009, 9, 2331; Cheng C et al. Nano Energy 2013, 2, 779) and bismuth vanadate (BiVO₄) (Kim T W and Choi K S. Science 2014, 343, 990) are being explored as potential photoanodes due to their relatively high stability in aqueous media. Among these photoanode candidates, BiVO₄ is being investigated for water oxidation due to its direct band gap of 2.4 eV and suitable band position for oxygen evolution, which can result in a low onset potential and all for utilization of the blue portion of the visible spectrum (Walsh A et al. Chem. Mater. 2009, 21, 547; Park Y et al. Chem. Soc. Rev. 2013, 42, 2321). However, the experimental performance achieved with BiVO₄ photoanodes to date has not matched the theoretical expectations. This can be due, at least in part, to the poor electron-hole separation efficiency, which can result in significant recombination in the bulky BiVO₄ (Zhong D K et al. J. Am. Chem. Soc. 2011, 133, 18370). The poor performance of BiVO₄ can also be due, at least in part, to slow oxygen evolution kinetics due to poor charge transport. The use of cobalt-based co-catalysts can aid in the electron transport within the BiVO₄ (Abdi F F et al. Chem Cat Chem 2013, 5, 490). Doping and morphology modification have also been reported to aid in the electron transport within the BiVO₄ material and to reduce the recombination probability (Seabold J A et al. Phys. Chem. Chem. Phys. 2014, 16, 1121; Karuturi S K et al. Nano Energy 2012, 1, 322). Nanostructuring BiVO₄ can enhance charge transport and electron-hole separation, leading to BiVO₄ with improved photoelectrochemical performance.

Plasmonic nanoparticles have been extensively explored due to their optical properties. Plasmonic nanoparticles have been used for an array of applications, including surface-enhanced spectroscopy, plasmonic lasers, biomedical imaging, and metamaterials. There has recently been growing interest in exploiting the plasmonic nanomaterials, which can localize optical energy and control the charge carrier generation with surface plasmon resonances, to improve the efficiency of photochemical and photovoltaic reactions such as in plasmonic enhancement of solar water splitting (Hou W and Cronin S B. Adv. Funct. Mater. 2013, 23, 1612; Warren S C and Thimsen E. Energ. Environ. Sci. 2012, 5, 5133; Chen H M et al. Chem. Soc. Rev. 2012, 41, 5654; Gao H et al. ACS Nano 2011, 6, 234). With their capability of manipulating light at the nanoscale, plasmonic metal nanostructures can be incorporated into semiconductor electrodes to improve water splitting by enhancing the light harvesting, charge generation and separation, and kinetics of chemical reactions, for example though plasmonic enhancements. The excitation of surface plasmon resonances (SPRs) at plasmonic metal nanostructures can concentrate sunlight at the metal-semiconductor interfaces to enhance the light absorption in the semiconductors. Therefore, thin films of semiconductors can be employed as electrodes in the PEC cells to reduce the exciton recombination rate and lower the production cost. However, the design of composite photoanodes has relied on “trial-and-error” approaches, leading to only moderate performance enhancement.

For photoelectrochemical applications, Au nanoparticles can be incorporated into semiconductors due to the chemical stability and broad optical response (e.g., from visible to infrared) of the Au nanoparticles (Tian Y and Tatsuma T. J. Am. Chem. Soc. 2005, 127, 7632). Mechanisms for plasmonic enhancement of chemical reactions can include (i) plasmon resonance energy transfer (PRET) from metal nanoparticles to the adjacent semiconductors, (ii) hot-electron injection, where electrons are generated and injected into the conduction band of semiconductors upon non-irradiative decay of surface plasmons, (iii) plasmonic heating, and (iv) local electromagnetic field concentration for the enhanced light absorption by semiconductors (Warren S C and Thimsen E. Energ. Environ. Sci. 2012, 5, 5133; Chen H M et al. Chem. Soc. Rev. 2012, 41, 5654; Schaadt D et al. Appl. Phys. Lett. 2005, 86, 063106). Au nanoparticles can improve the water splitting performance on various materials via one or more of these mechanisms.

Hot-electrons injection enhancement is particularly promising among the various approaches. Hot electrons from the decay of surface plasmons on metal nanostructures can enter the conduction band of semiconductors and interact with protons to form hydrogen, while the holes in the metal nanostructures can accept electrons from the electrolyte for oxygen production, thereby enhancing the chemical reactions in PEC water splitting. Since the surface plasmon resonances of plasmonic metal nanostructures can be tuned to cover a broad range of wavelength, e.g., the solar spectrum, one can use the hot electrons to sensitize wide-band semiconductors to harness the visible and near-infrared lights that are otherwise wasted.

Metal nanostructures on semiconductor electrodes can also help suppress optical reflection and thereby enhance light utilization. The high refractive indices of semiconductors can result in large reflection loss of incident light at the electrode surfaces. Metal nanoparticle can reduce the reflection by preferentially scattering the light into the semiconductors. Metal nanostructures in rationally designed arrays can even lead to negligible reflection at the electrodes, significantly enhancing the light absorption and energy conversion efficiency.

In spite of numerous experiments, mechanistic understanding of the mechanisms of plasmonic enhancement of photoelectrochemical performance has been inconsistent due to the difficulty in decoupling the different mechanisms in the measurements. Therefore, experiments that aim to probe, understand and optimize each of the plasmonic enhancement mechanisms are highly desired in order to maximize the performance of photoelectrochemical cells.

Herein, nanoporous BiVO₄ materials decorated with Au nanoparticles (Au—BiVO₄) were fabricated and tested as photoanodes, which exhibited improved photocurrent response and solar energy conversion efficiency. The high surface area of the nanoporous BiVO₄ and the substantially uniform dispersion of Au nanoparticles on the nanostructured surfaces synergized multiple enhancement mechanisms for the Au—BiVO₄ systems. These enhanced mechanisms included, for example, enhanced charge and carrier collection, plasmon-induced electron and energy transfer, and plasmon-enhanced electromagnetic fields. The cumulative effect was enhanced utilization of the generated charges. As a result, an AM 1.5G photocurrent density of 5.1±0.1 mA/cm² at 1.23 V vs RHE was achieved along with >99% Faraday efficiency. No co-catalysts were integrated with the photoanodes. The Au—BiVO₄ photoanodes in combination with their relatively simple electrochemical and chemical deposition techniques lead to robust, high-performance solar water oxidation in tandem or hybrid photoelectrochemical cells. Moreover, the contributions from hot-electron injection and plasmon resonance energy transfer were analyzed, and it was concluded that the hot-electron injection can play a role in the plasmonic enhancement of the photoelectrochemical performance.

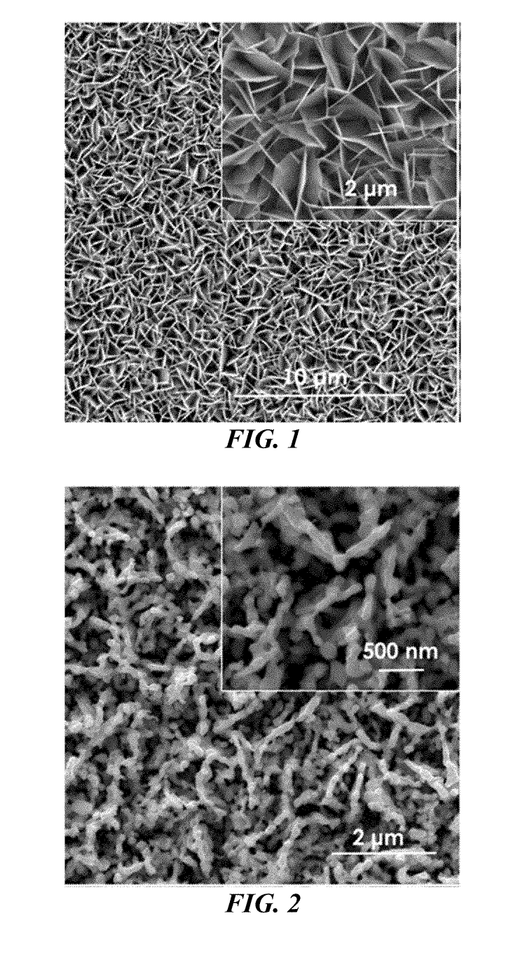

A series of nanostructured BiVO₄ electrodes with variable loadings of Au nanoparticles were prepared and their photoelectrochemical performances were studied. For the fabrication of the BiVO₄ electrodes, all the reagents were of analytical grade and used without further purification, and deionized water was used in all experiments. Nanoporous BiVO₄ films were synthesized on fluorine-doped tin oxide (FTO) glass substrate with nanostructured BiOI films (e.g., an array of BiOI nanoflakes) as templates using an electrodeposition method reported previously (Liu J et al. Nano Energy 2013, 2, 328). Briefly, 50 mL 0.8 M Bi(NO₃)₃ and 8 M KI (pH=1.7) was added to 20 mL of 0.23 M p-benzoquinone absolute ethanol solution. Pt wire and saturated Ag/AgCl were used as the counter electrode and reference electrode in all the electrochemical experiments. The cathodic deposition was carried out potentiostatically at −0.14 V for 3 min. A scanning electron microscopy (SEM) image of the resulting nanostructured BiOI films is shown in FIG. 1, which indicates that the nanostructured BiOI films comprise oriented BiOI nanoflakes (ca. 20 nm in thickness) with voids between them. These voids can limit the grain growth of BiVO₄ converted from BiOI, which can lead to a high surface area of the BiVO₄ films.

The BiOI precursor films were further pipetted with 150 μL of 0.2 M VO(acac)₂ in DMSO and annealed in 450° C. for 2 hrs. Afterwards, the films were washed by soaking them in 1 M NaOH solution for 30 min. The resulting nanoporous BiVO₄ electrodes were rinsed with deionized water and dried at room temperature. FIG. 2 shows the BiVO₄ electrodes are comprised of numerous spherical nanoparticles (average diameter of 70±10 nm) that form a 2D nanoporous network. These BiVO₄ nanoparticles have smaller dimensions than the hole diffusion length. Therefore, the network of BiVO₄ nanoparticles can lead to efficient electron-hole separation. Such 2D nanoporous structures can be superior for photoelectrochemical and photovoltaic applications due to their enhanced capability of charge carrier separation and collection. The spherical particles have small radii, and carriers that are generated therein can diffuse to their surfaces before they recombine.

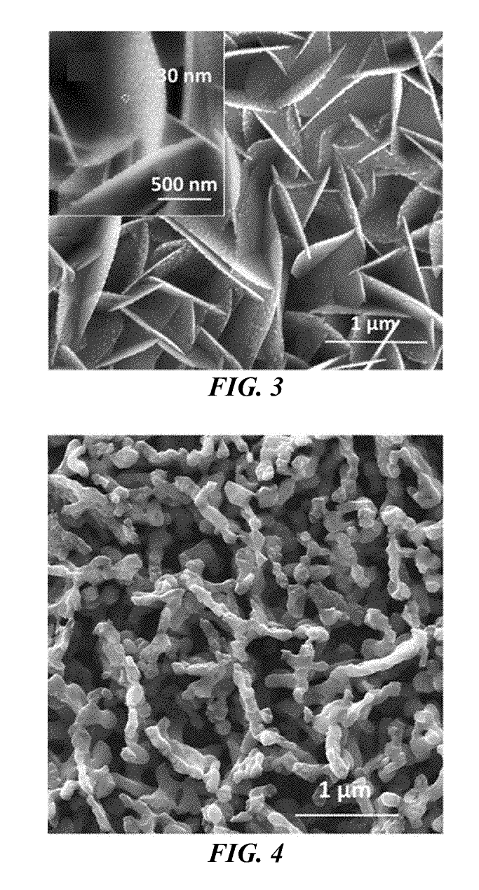

For the decoration of the BiVO₄ electrodes with Au nanoparticles, colloidal Au nanoparticles were prepared in a mixed solution of 25 mL of sodium citrate (1%) and 250 mL of Au metal salt (HAuCl₄, 0.4 mM) solution. The solution was heated at 90° C. for 15 min and then cooled. The as-prepared BiVO₄ substrates were immersed in the solution for variable durations (e.g., 1 hour, 3 hours, 6 hours, 12 hours, and 24 hours). Following immersion for the selected duration, the resulting sample was thoroughly washed by deionized water, and dried at room temperature. The samples were then annealed in an ambient environment at 350° C. for 1 hour to generate Au nanoparticles on the surface of the nanoporous BiVO₄. FIG. 3 and FIG. 4 show the scanning electron microscopy (SEM) images for BiOI and BiVO₄ films after the Au deposition for 12 hours, respectively. The formation of the Au nanoparticles with an average diameter of 30 nm can be clearly seen on the BiOI films in FIG. 3.

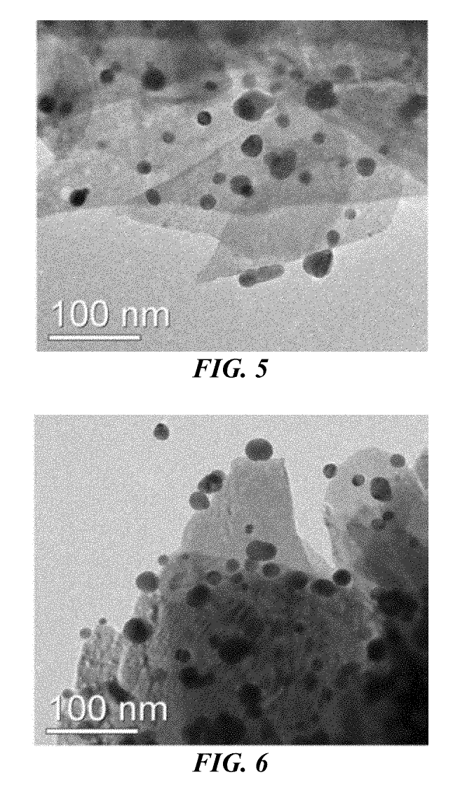

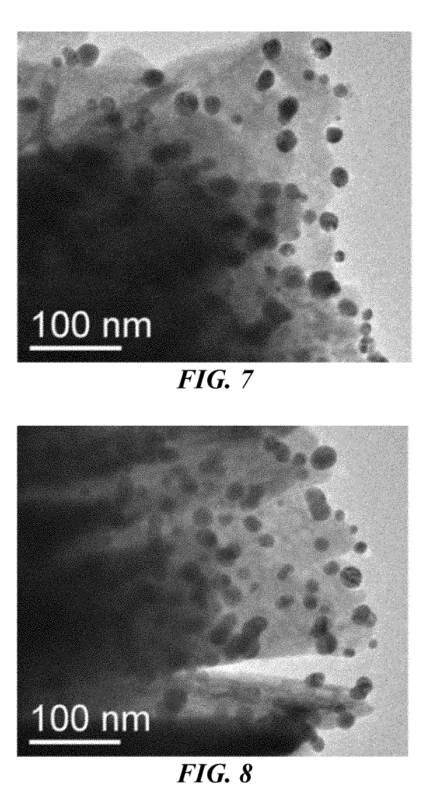

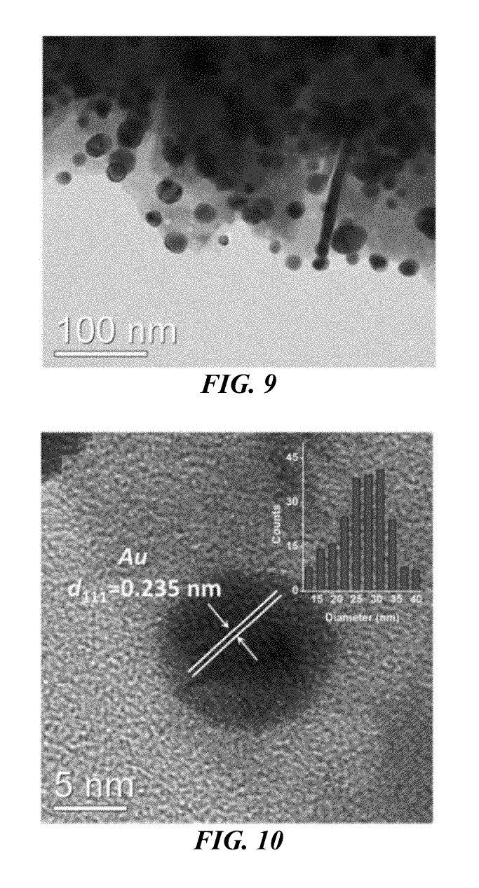

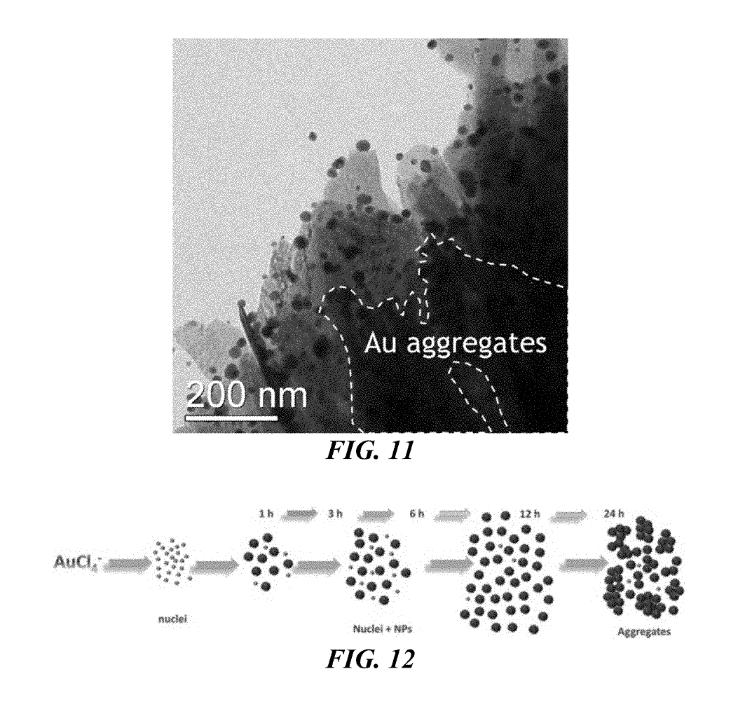

Transmission electron microscope (TEM) images of the BiVO₄ samples with Au nanoparticle loading times of 1 hour, 3 hours, 6 hours, 12 hours, and 24 hours are shown in FIG. 5-FIG. 9, respectively. Throughout the deposition process, the mean size of the Au nanoparticles was 25-32 nm (FIG. 10). Within this range, the particle size distribution increased as the Au loading time was prolonged. The Au nanoparticles start to aggregate at longer deposition times, especially in the case of the 24 hours sample (e.g., 24 hours of Au deposition; FIG. 11), which can lead to the formation of a thin layer of Au nanoparticles. A schematic representation of the formation process of the Au nanoparticles is shown in FIG. 12.

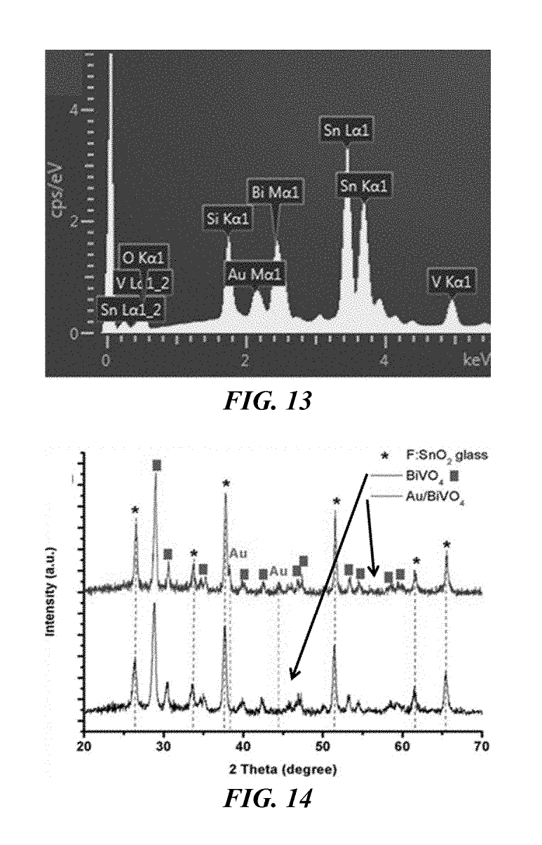

The structures and compositions of the samples were further characterized with scanning electron microscopy (SEM) (FEI Quanta 650) integrated with an energy dispersive spectroscopy (EDS) detector and X-ray diffractometer (XRD) (Rikagu MiniFlex 600). Energy dispersive spectroscopy (EDS) was performed on the BiVO₄ samples after the Au deposition to confirm the chemical compositions of the films. The EDS spectra, for example as shown in FIG. 13, displayed a distinct Au peak in addition to peaks for Bi, V and O. The corresponding XRD spectrum is shown in FIG. 14, and confirms the scheelite-monoclinic structure (JCPDS #:14-0688) of BiVO₄ and the presence of cubic gold (JCPDS #:2-1095), further verifying the crystalline phase of Au—BiVO₄.

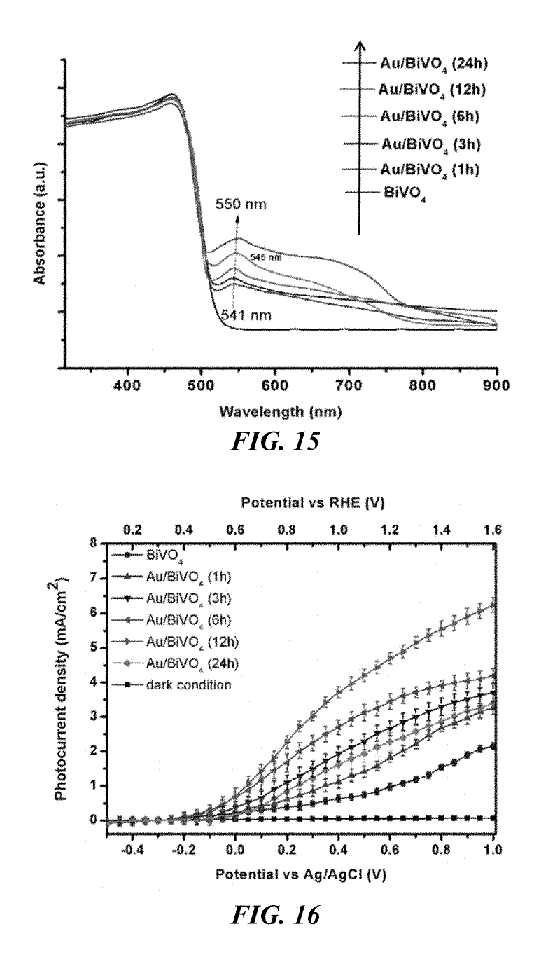

Optical diffuse reflectance spectra (Cary 5000 UV-Vis-NIR spectrometer) of pristine BiVO₄ and Au—BiVO₄ with different Au loadings were measured to investigate the effects of the Au nanoparticles on the optical properties of the BiVO₄ (FIG. 15). Pristine BiVO₄ has an electronic band gap of 2.4 eV, which corresponds to a wavelength of 515 nm. Indeed, the absorption spectrum of pristine BiVO₄ exhibited a drop in absorption around a wavelength of 515 nm (FIG. 15). Au nanoparticles can exhibit localized surface plasmon resonances (LSPRs), the light-coupled coherent oscillation of free electrons in the nanoparticles (Zhao J et al. Acc. Chem. Res. 2008, 41, 1710). The localized surface plasmon resonance can depend on nanoparticle shape and size, which means the localized surface plasmon resonances can be tuned (e.g., by tuning the size and/or shape of the nanoparticles) to overlap with the semiconductor absorption wavelengths to thereby enhance physical and chemical processes. As seen in FIG. 15, the maximum absorbance of the various Au—BiVO₄ samples corresponds to the localized surface plasmon resonance (˜540 nm-550 nm). Furthermore, the absorbance that can be attributed to the surface plasmon resonance of the Au nanoparticles gradually increased as the deposition time increased, suggesting that the loading of Au can be effectively controlled to optimize the absorption conditions for the photoelectrochemical reactions. The increased loading time also causes a redshift (from 541 nm to 550 nm) and broadening in the localized surface plasmon resonance peak of the composites. The red shift can be attributed to the progressive deposition of Au particles upon the BiVO₄. The peak shift can be caused by the changes in the dielectric of the environment around the particle and also the variation of inter-particle distance. In addition to the major plasmon resonance peak, the absorption peak broadened to cover longer wavelengths in higher Au loading composites. This phenomenon can be attributed to Au nanoparticle aggregation, where there can be small inter-particle distances within the aggregates that can result in interactions between neighboring particles, which affect the surface plasmon resonance effect (Kelly K L et al. J. Phys. Chem. B 2003, 107, 668).

Electrochemical measurements were performed systematically to evaluate the plasmonic effects on the photoelectrochemical performance of BiVO₄ loaded with different amount of Au nanoparticles. Photoelectrochemical measurements of the Au—BiVO₄ photoanodes were conducted in a 3-neck glass electrode cell with the Au—BiVO₄ photoanodes being measured as the working electrode. The illumination source was a 150 W Xe arc lamp (Newport, 6255) directed at the quartz photoelectrochemical cell (100 mW/cm²). The photoelectrochemical properties of the Au—BiVO₄ photoanodes were examined in 0.2 M Na₂SO₄ aqueous solution at pH=7 under AM 1.5G illumination and dark conditions. All the electrochemical measurements were performed on a CHI 660E electrochemical workstation at room temperature. The gas evolution was conducted at the same condition with a bias of +1.0 V vs RHE.

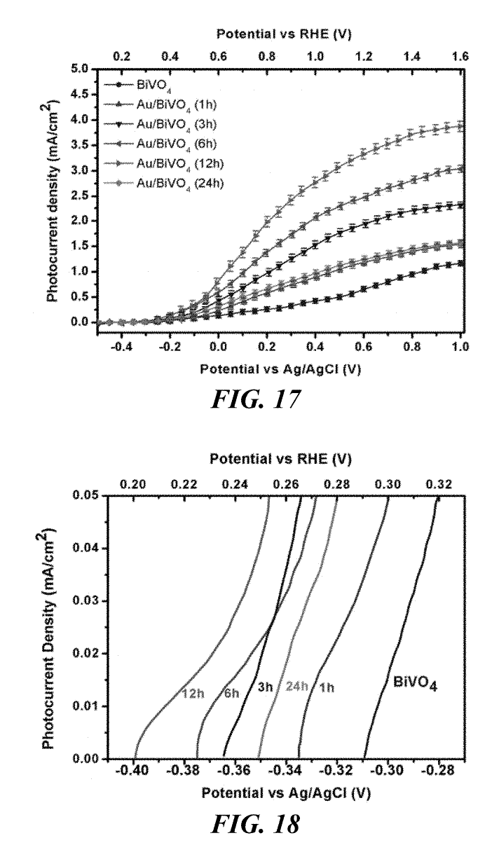

Linear sweep voltammetry (LSV) of the pristine and Au—BiVO₄ photoanodes was conducted with back-side illumination, with the resulting voltammograms shown in FIG. 16. The data points and error bars in FIG. 16 represent the average and standard deviation values from the measurements of multiple samples. The dark scan led to negligible current. Under illumination, the Au—BiVO₄ electrodes exhibited an increased photocurrent as a function of loading of Au nanoparticles, up to 12 h. A similar trend was also found for front-side illumination (FIG. 17). The Au—BiVO₄ electrode with an Au nanoparticle loading time of 12 hours yielded a pronounced photocurrent, which started from −0.22 V and increased to 5.10 mA/cm² when +1.23 V vs RHE was applied (FIG. 16). This corresponds to an almost 5 times increase over pristine BiVO₄ (1.1 mA/cm² at the same potential). This suggests that decoration with the Au nanoparticles can promote the harvesting of solar light, for example, via plasmon-induced enhancement. Moreover, the current onset potential shifted cathodically as a function of loading of Au nanoparticles up to 12 h (FIG. 18), implying that the kinetics of oxygen evolution, as well as surface recombination of electrons (e⁻) and holes (h⁺) can be improved via plasmonic enhancement and/or the electrocatalytic effect of Au. It is worth reiterating that no co-catalyst was added onto the Au—BiVO₄ electrodes. In the presence of an appropriate co-catalyst, the photocurrent onset potential can be even lower.

A decrease in photocurrent occurs for the BiVO₄ electrode with the Au loading time of 24 hours for both back-side (FIG. 16) and front-side (FIG. 17) illumination, which can arise from the blocking effect of the larger number of Au nanoparticles (or Au nanoparticle aggregates) on the surfaces (Chen H M et al. ACS Nano 2012, 6, 7362). For both back-side (FIG. 16) and front-side (FIG. 17) illumination, the blocking effect of the incident light by the Au nanoparticles doubled upon increasing the loading time from 12 hours to 24 hours. Additionally, Au nanoparticles can also behave as trap centers for photoelectrons (Chen H M et al. ACS Nano 2012, 6, 7362) and collect some photogenerated electrons from the BiVO₄, resulting in a negative effect on the photoresponse. As a result, the optimal performance herein of the Au—BiVO₄ electrode with the Au nanoparticle loading time of 12 hours can arise from the balance between the plasmonic enhancement and the blocking effect of Au nanoparticles.

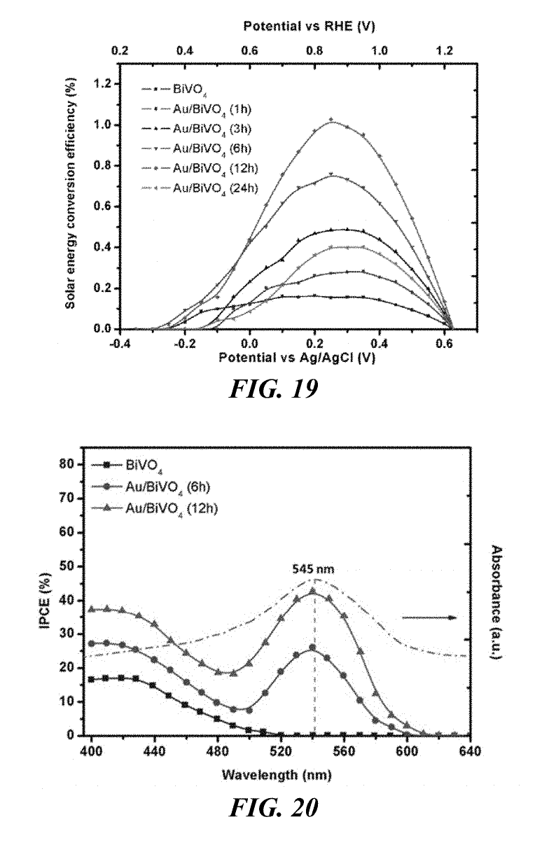

For further insights into the photoelectrode properties, the solar energy conversion efficiency, (η), was calculated from the experimental J-V curves by assuming 100% Faradaic efficiency according to the following equation:

$$η ( λ ) = \frac{\vert J \vert \times ( 1.229 - {V}_{bias} )}{{P}_{i n}} \times 100 \% \qquad ( 1 )$$

where J is the photocurrent density (mA/cm²), Pin is the incident illumination power density (AM 1.5G, 100 mW/cm²) and Vbias is the applied bias vs RHE (V). As shown in FIG. 19, η exhibits a similar trend to the photocurrent as a function of Au loading time. Compared to pristine BiVO₄ at 0.80 V, the η of Au—BiVO₄ (1 hours˜12 hours) is enhanced almost 5 times from 0.15% to 1.00%.

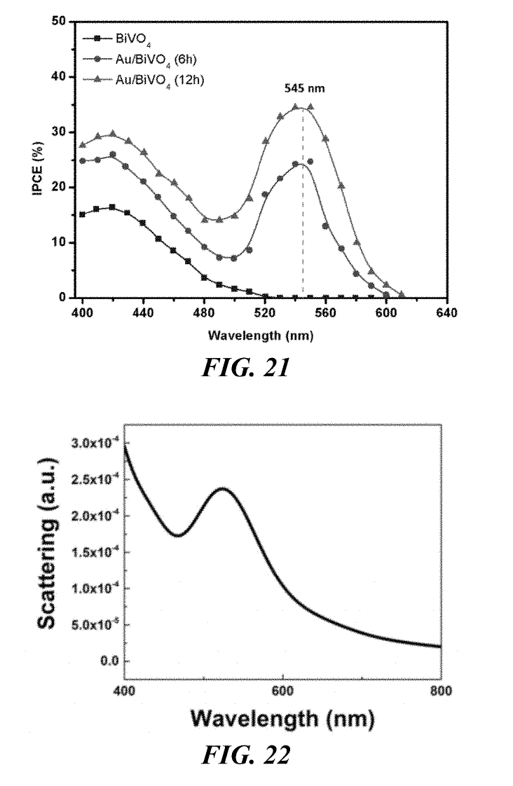

The incident photon-to-current conversion efficiency (IPCE) was calculated according to the following equation:

$$I P C E ( λ ) = \frac{1240 J ( λ )}{λ \times P ( λ )} \times 100 \% \qquad ( 2 )$$

where λ is the wavelength (nm), J(λ) is the photocurrent density (mA/cm²), and P(λ) is the incident power density of the monochromated light (mW/cm²). The incident photon-to-current conversion efficiency (IPCE) can be used to quantitatively investigate the relations between the photoactivity and the light absorption of the electrodes. The incident photon-to-current conversion efficiency of all the electrodes were measured at 1.0 V vs RHE under the same conditions. The incident photon-to-current conversion efficiency spectra with back-side illumination are shown in FIG. 20. The incident photon-to-current conversion efficiency spectrum of pristine BiVO₄ exhibits a photoresponse up to 520 nm, in accordance with the absorption edge of BiVO₄ (FIG. 20). An increase in the performance is observed upon addition of Au nanoparticles (FIG. 20). Additional photoactivity was observed in the Au—BiVO₄ samples up to 600 nm, where the optical absorption of Au nanoparticles starts to subside. A similar trend was observed in front-side illumination (FIG. 21).

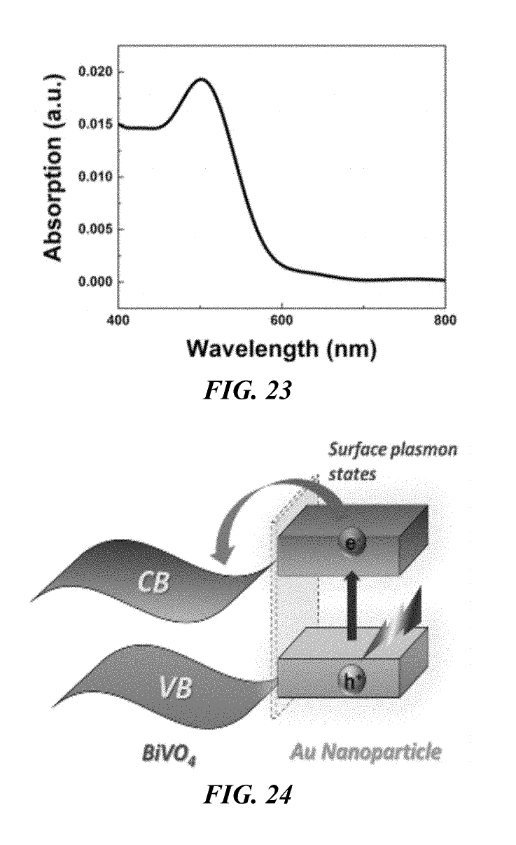

To investigate the mechanisms of the increased photoactivity, different plasmonic phenomena were considered and analyzed. The effect of resonant photon scattering by nanoparticles in increasing the path length of photons in BiVO₄ is minimal since scattering for Au nanoparticles below 50 nm is minimal (FIG. 22) compared to the absorption (FIG. 23) (Burda C et al. Chem. Rev. 2005, 105, 1025). Plasmonic heating is also unlikely as the thermal energy caused by plasmonic heating is less than the amount of energy required for the water-splitting (1.23 eV) (Liu Z et al. Nano Lett. 2011, 11, 1111). On the other hand, there is a small overlap between the optical absorption spectra of the pristine BiVO₄ and that of the Au nanoparticles, which can allow for plasmon resonance energy transfer to occur (Warren S C and Thimsen E. Energ. Environ. Sci. 2012, 5, 5133). The elimination of the above phenomena (e.g., scattering and heating) suggests that the major contribution to the plasmonic enhancements observed herein can be via hot-electron injection and plasmon resonance energy transfer. The additional strong photoresponse from 520 nm to 570 nm, which is beyond the absorption edge of BiVO₄, after adding Au nanoparticles confirms the existence of charge transfer from the Au nanoparticles to BiVO₄. Upon decay of the localized surface plasmon resonance, hot electrons are injected to the conduction band (CB) of BiVO₄, because the photoexcited plasmons can promote single electrons to higher energy states in the Au nanoparticle and the energy of the hot electrons is higher than the conduction band of BiVO₄. The injection of hot electrons from the Au nanoparticles into the conduction band of the BiVO₄ is shown schematically in FIG. 24.

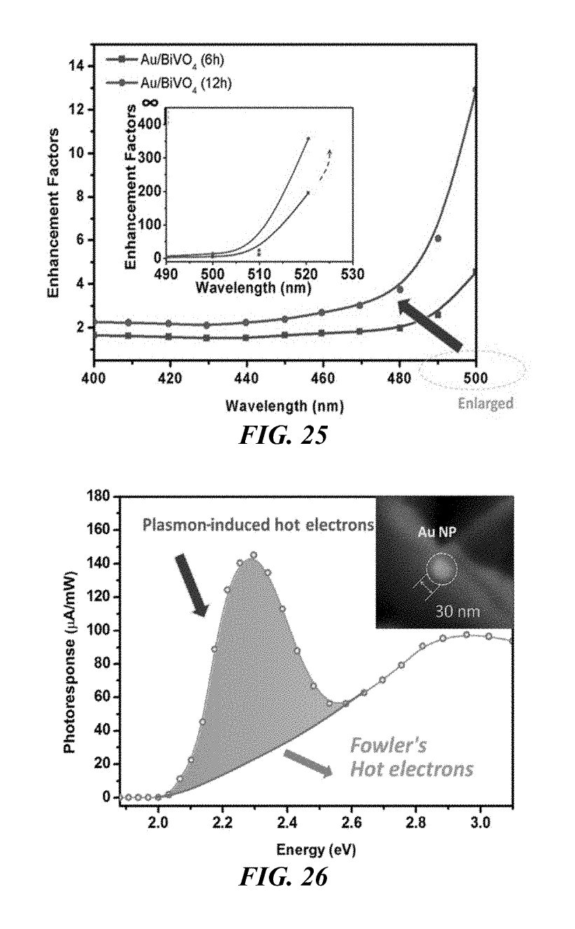

The incident photon-to-current conversion efficiency enhancement factors were quantified by dividing the incident photon-to-current conversion efficiency values of the 6 h and 12 h samples with those of pristine BiVO₄ (FIG. 25). The incident photon-to-current conversion efficiency peak at 420 nm is because of the photoactivity of BiVO₄ in this range, but the enhancement factors are limited to about 1.2 from 400 nm to 450 nm, indicating a minor contribution via plasmon resonance energy transfer for this wavelength range. In contrast, the enhancement factors start to increase drastically due to stronger plasmonic effects at wavelengths above 450 nm, which match well with the wavelength of the Au nanoparticle localized surface plasmon resonances (FIG. 20). Beyond 520 nm, the enhancement factor rises steeply to over 100 (FIG. 25, inset). Due to the negligible contribution from the semiconductor above 543 nm, the enhancement factor approaches infinity (FIG. 25, inset). Therefore, the majority photocurrent enhancement can be attributed to hot-electron injection. Optimization of the amount of Au nanoparticles (e.g., optimization of the Au nanoparticle deposition time) can maximize the plasmonic effects in the Au—BiVO₄ system, for example, by enhancing the hot-electron injection.

In recent years, the roles of hot electrons in photoelectrochemical cells have become of greater interest (Warren S C and Thimsen E. Energ. Environ. Sci. 2012, 5, 5133; DuChene J S et al. Angew. Chem. Int. Ed. 2014, 53, 7887). There have been reports that suggest the existence of hot-electron injection when the size of Au nanoparticles is around 30 nm (Sil D et al. ACS Nano 2014, 8, 7755). Fowler's theory, which has been used to analyze both solid-state devices and photoelectrochemical cells, was used to further confirm the existence of hot-electron injection (Chen H M et al. ACS Nano 2012, 6, 7362; Knight M W et al. Science 2011, 332, 702). As per Fowler's theory, the count of photoelectrons with sufficient energy to overcome the Schottky barrier is:

$${η}_{i} = {C}_{F} \frac{{( hv - ϕ )}^{2}}{hv} \qquad ( 3 )$$

where C_{F} corresponds to the Fowler emission coefficient, hv is the photon energy, and φ is the Schottky barrier energy. Based on the incident photon-to-current conversion efficiency results, which indicated that wavelength range above about 450 nm can be of interest, the photocurrent plots were fitted using Fowler's theory with the parameters n=2 and φ=1.8 eV for the wavelength range of 2.1-2.5 eV (e.g., 495-590 nm) (FIG. 26). A bias of 0.4 V vs Ag/AgCl (1.0 vs RHE) was applied to the electrodes during the measurements, meaning the Schottky barrier should be 2.2 eV with zero bias.

The deviation of the photocurrent from Fowler's theory implies that there is injection of hot electrons with energy higher than the barrier height, which could transfer from the Au nanoparticles to the BiVO₄ upon decay of the localized surface plasmon resonance. The probability of injection and plasmon resonance energy transfer probability is higher for more energetic electrons, such as electrons excited with the light of shorter wavelength, for example from 300 nm to 525 nm. Therefore, both hot electrons and plasmon resonance energy transfer can contribute to the photocurrent under light illumination within that range. In addition, the profile of the plot in FIG. 26 is similar to that of the localized surface plasmon resonance peak of the Au nanoparticles (˜545 nm). Thus, the increase in the photocurrent of Au—BiVO₄ electrodes can indicate that the localized surface plasmon resonance of the Au nanoparticles can promote hot-electron flow from the Au nanoparticles to the BiVO₄. In other words, the localized surface plasmon resonance of the Au nanoparticles can facilitate the generation of hot electrons and plasmon resonance energy transfer that can contribute to the performance improvement of the Au—BiVO₄ electrodes over the Fowler emission.

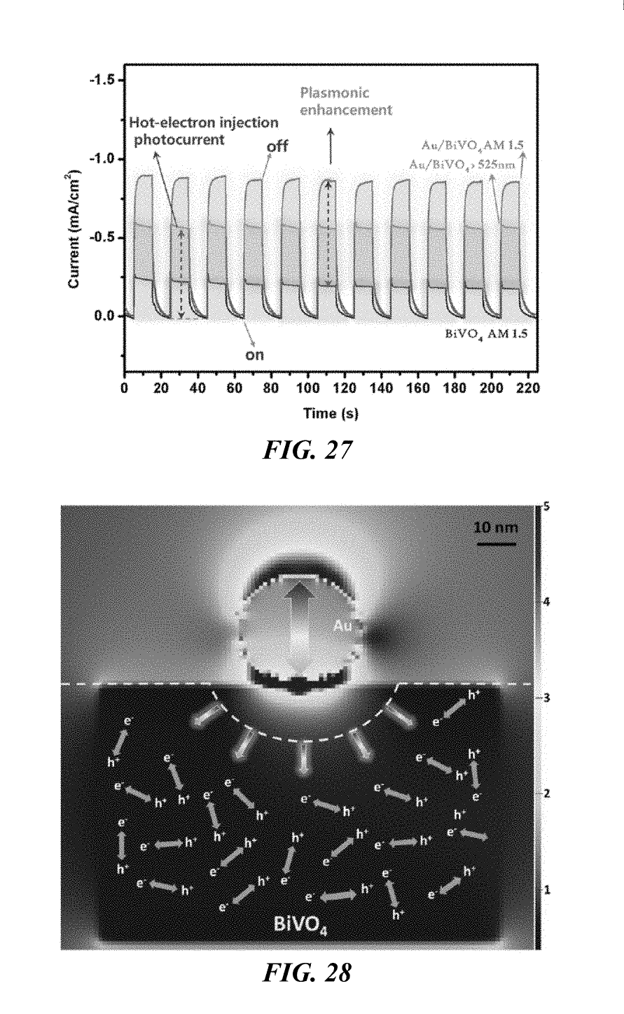

To verify the contributions from hot-electron injection and plasmon resonance energy transfer, the Au—BiVO₄ photoelectrode fabricated using 12 hours of Au deposition was further tested under on-off cycle illumination with solar spectrum and 525 nm long-pass filter (FIG. 27). Since the activity of BiVO₄ is up to 520 nm, the photoresponse of pristine BiVO₄ is included as a control. The activity of the pristine BiVO₄ overlapped with the photoresponse of Au—BiVO₄ (FIG. 27). The difference in the photocurrents between Au—BiVO₄ and pristine BiVO₄ under solar illumination depicts the overall plasmonic enhancement. A 525 nm long-pass filter attached to the solar simulator was used to isolate the role of hot-electron injection. The photocurrent observed in this case is evidence for the hot-electron injection, since pristine BiVO₄ has no activity above 525 nm. Further, the results indicate that the enhancement at wavelengths >525 nm contributes ˜90% of the plasmonic enhancement. The enhancement between 300 nm to 525 nm is also attributed to plasmon resonance energy transfer, because there is a small overlap of the BiVO₄ and Au nanoparticles absorbance. Since the localized surface plasmon resonances are sensitive to the shape and size of Au nanoparticles, it is possible to extend the absorption to the entire visible range by incorporation of different types of Au nanoparticles, such as Au nanorods, and/or by incorporation of different sizes of Au nanoparticles (Pu Y C et al. Nano Lett. 2013, 13, 3817).

To further understand the photoelectrochemical enhancements in the Au—BiVO₄ electrodes, the plasmon-enhanced electromagnetic field was studied using finite-difference time-domain (FDTD) method. The numerical simulations were performed with Lumerical, a commercial finite-difference time-domain (FDTD) Maxwell Equation solver. Based on experimental measurements, a spherical Au nanoparticle (diameter=30 nm) was attached onto the surface of a BiVO₄ nanoplate with dimensions of 70 nm×100 nm×100 nm in the numerical simulations. Linearly polarized light was illuminated normally onto the substrate in the simulations. The reflectance light and electromagnetic field were collected with a two-dimensional (2D) frequency-domain power detector and electric-field detector at the top, respectively, in the simulations.

The electromagnetic response of the hybrid Au—BiVO₄ electrodes, as shown in FIG. 28, is dominated by local “hot spots”. The main intense local fields in one Au nanoparticle can be seen in FIG. 28, which shows the electric field distribution of the hot spot regions. In this local hot spot region, the electric field intensity at the BiVO₄ surface is ˜5 times higher than that of the incident electric field intensity. This indicates that the photon absorption rate (and hence e⁻-h⁺ pair generation rate) for the Au—BiVO₄ is higher than for pristine BiVO₄. The penetration length of field enhancement into the BiVO₄ is 30 nm. Thus, a higher carrier generation resulting from hot-electron injection, plasmon resonance energy transfer, and electromagnetic field enhancement is observed in the Au—BiVO₄ photoanode. Further, the nanoporous architecture can aid in the efficient utilization of e⁻-h⁺ pairs. The e⁻-h⁺ pairs are readily separated under the influence of the surface potential and their travel distance to the BiVO₄ surface is shortened (e.g., compared to a bulk/non-nanostructures electrode). Thus, a combination of higher e⁻-h⁺ pair generation and efficient charge separation in the Au—BiVO₄ electrodes discussed herein can lead to superior photoelectrochemical performance compared to previously reported systems with similar configurations (Xie S et al. Nano Energy 2014, 10, 313; Chen H M et al. ACS Nano 2012, 6, 7362; Zhang L et al. Small 2014, 10, 3970).

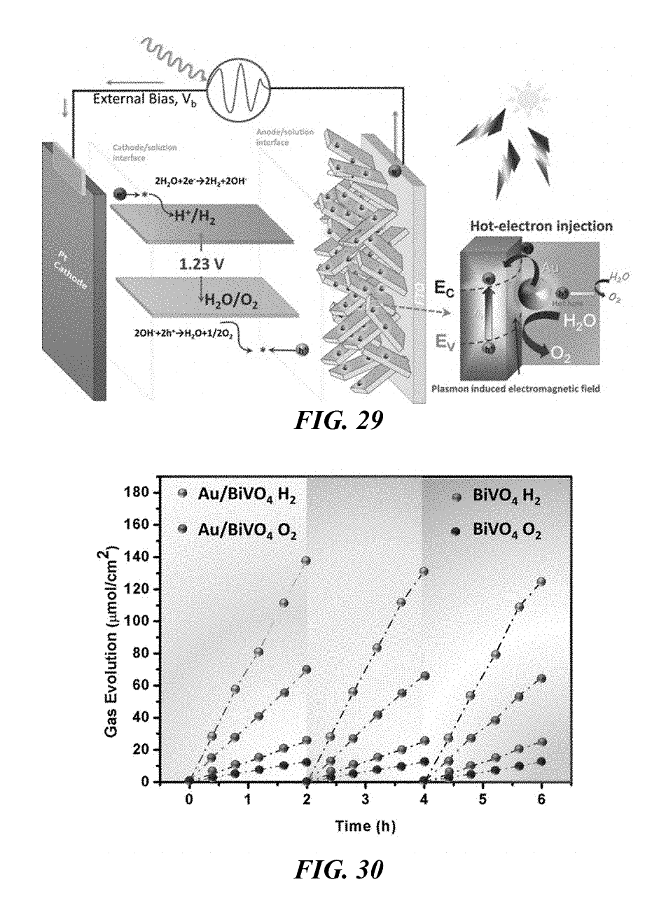

FIG. 29 depicts a pictorial model of the plasmonic enhancement mechanism. When the Au—BiVO₄ photoanode absorbs light with energies above the band gap of BiVO₄, the photoelectrons generate and move to the conduction band of BiVO₄. Simultaneously, the Au nanoparticles absorb the incident irradiation, generating hot electrons and strengthening the electromagnetic field at the metal nanoparticle-semiconductor interfaces. These hot electrons can be injected over the Schottky barrier into the conduction band of BiVO₄ and can eventually move on to the cathode, where they can interact with protons to form hydrogen, while the holes in the Au nanoparticles can accept electrons from electrolyte and generate oxygen (Tian Y and Tatsuma T. J. Am. Chem. Soc. 2005, 127, 7632; Lee J et al. Nano Lett. 2012, 12, 5014). Therefore, with continuous plasmon hot-electron injection, excited Au nanoparticles can undergo redox reactions evolving hydrogen and oxygen from water. At the bottom of the conduction band, additional vacancies can be formed by the plasmon-induced electromagnetic field. These vacancies can facilitate the generation of photoelectrons by direct excitation. This electromagnetic field is not uniform on the plasmonic metal surface, so the formation of electron-hole pairs should be larger in the region of semiconductor closest to the Au nanoparticles. The surface potential can promote separation of e⁻-h⁺ pairs and can shorten their distance to travel to the surface of BiVO₄.

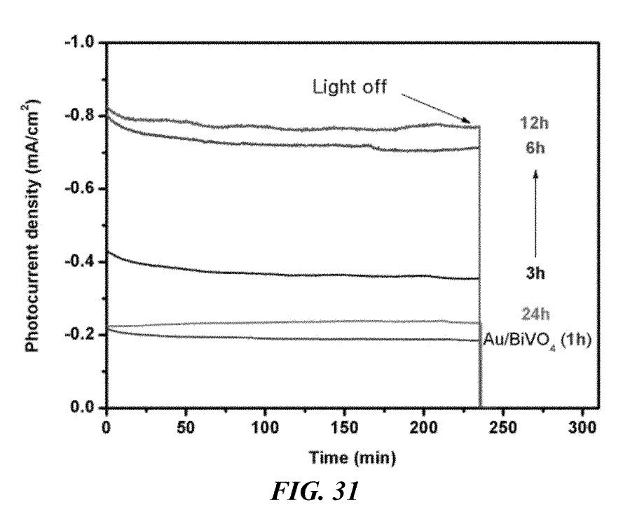

Both hydrogen and oxygen evolution tests of the assembled photoelectrochemical cell were performed (FIG. 30) to investigate whether the photocurrent generated is exclusively for water splitting, or if there are contributions from any side reactions. The ratio of evolution rates of H₂ and O₂ is close to the stoichiometric value of 2.0, with rates of 68.72±0.05 μmol·h⁻¹·cm⁻² for H₂ and 35.15±0.05 μmol·h⁻¹·cm⁻² for O₂. Assuming 100% Faradaic efficiency, the evolution rates of H₂ and O₂ should be 72.38 μmol·h⁻¹·cm⁻² and 36.19 μmol·h⁻¹·cm⁻², respectively, for Au—BiVO₄ (12 hours) at an average photocurrent of 3.88 mA/cm². Similarly, the theoretical (and actual) amount of pristine BiVO₄ gas evolution is 12.94 μmol·h⁻¹·cm⁻² (12.76 μmol·h⁻¹·cm⁻²) for H₂ and 6.471 μmol·h⁻¹·cm⁻² (6.285 μmol·h⁻¹·cm⁻²) for O₂. Consequently the faradaic efficiencies for both gases are higher than 95%, indicating that the observed photocurrent can be fully attributed to water splitting. This reveals the plasmonic effects can significantly enhance the water oxidation efficiency. The photocurrents possess a minimal decay of less than 5% in long-term tests (FIG. 31), implying the as-prepared photoanodes have high stability. The decay at the higher photocurrent is due to O₂ bubble trapping within the nanostructure of BiVO₄.

Herein, nanoporous bismuth vanadate (BiVO₄) material decorated with plasmonic Au nanoparticles were developed as the photoanode material for PEC cells. The Au—BiVO₄ photoanodes exhibited high surface area, short carrier-diffusion length, and plasmonic enhancement for efficient photoelectrochemical water splitting applications. The plasmonic enhancement resulted in an AM 1.5 photocurrent of 5.1±0.1 mA/cm² at 1.23 V vs RHE, which is considerably higher than those reported for the relevant systems. The photocurrent was enhanced 5 times with respect to pristine BiVO₄, with over 95% total Faradaic efficiency, long-term stability and high energy-conversion efficiency.

The overall performance enhancement was attributed to the synergy between the nanoporous architecture of BiVO₄ and the surface plasmons of Au nanoparticles. Further, different plasmonic effects of the Au nanoparticles in the photoanodes were analyzed and decoupled. Through mechanistic studies, it was established that the plasmon-induced hot electron injection is a major contributor to the photoelectrochemical performance enhancement of the Au—BiVO₄ photoanodes. Plasmon resonance energy transfer and the plasmon-enhanced electromagnetic field can also contribute to the photoelectrochemical performance. In addition, the e⁻-h⁺ pairs in BiVO₄ can be separated under the influence of the surface potential, and the nanoporous structure shortens the distance the e⁻-h⁺ pairs have to travel to the surface.

These Au—BiVO₄ nanostructures can represent next-generation photoanode materials in a practical water-splitting system, which can efficiently absorb a large portion of the solar spectrum, be catalytic for both water oxidation and proton reduction, promote facile charge transfer, be composed of abundant elements, and remain stable in electrolyte under illumination.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

The methods of the appended claims are not limited in scope by the specific methods described herein, which are intended as illustrations of a few aspects of the claims and any methods that are functionally equivalent are intended to fall within the scope of the claims. Various modifications of the methods in addition to those shown and described herein are intended to fall within the scope of the appended claims. Further, while only certain representative method steps disclosed herein are specifically described, other combinations of the method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

What is claimed is:

1. A nanostructured electrode comprising: a plurality of plasmonic particles having a plasmon resonance energy in electromagnetic contact with a nanostructured semiconductor having a band gap with a conduction band, wherein at least a portion of the plasmon resonance energy of the plurality of plasmonic particles is higher in energy than the conduction band of the nanostructured semiconductor.

2. The nanostructured electrode of claim 1, wherein the plasmon resonance energy of the plurality of plasmonic particles at least partially overlaps with the band gap of the nanostructured semiconductor.

3. The nanostructured electrode of claim 1, wherein the nanostructured semiconductor comprises a continuous semiconductor phase comprising a plurality of semiconductor particles.

4. The nanostructured electrode of claim 3, wherein the plurality of semiconductor particles have an average particle size of from 20 nm to 120 nm.

5. The nanostructured electrode of claim 1, wherein the nanostructured semiconductor, the nanostructured electrode, or a combination thereof comprises a metal oxide, a metal sulfide, a metal selenide, a metal nitride, or combinations thereof.

6. The nanostructured electrode of claim 1, wherein the nanostructured semiconductor comprises Fe₂O₃, WO₃, Ta₃N₅, TaON, TiO₂, ZnO, CdS, CdSe, BiVO₄, or combinations thereof.

7. The nanostructured electrode of claim 5, wherein the nanostructured electrode comprises a metal oxide, a metal sulfide, a metal selenide, or a metal nitride, and the metal oxide, metal sulfide, metal selenide, or metal nitride comprises a metal selected from the group consisting of Be, Mg, Al, Ca, Sc, Ti, V, Cr, Mn, Fe, Co, Ni, Cu, Zn, Ga, Sr, Y, Zr, Nb, Mo, Tc, Ru, Rh, Pd, Ag, Cd, In, Sn, Ba, Hf, Ta, W, Re, Os, Ir, Pt, Au, Hg, Tl, Pb, Bi, La, Ce, Pr, Nd, Pm, Sm, Eu, Gd, Tb, Dy, Ho, Er, Tm, Yb, and combinations thereof.

8. The nanostructured electrode of claim 1, wherein the plurality of plasmonic particles comprise a plurality of metal particles, the plurality of metal particles comprising a metal selected from the group consisting of Au, Ag, Pt, Pd, Cu, Al, and combinations thereof.

9. The nanostructured electrode of claim 1, wherein the plurality of plasmonic particles have an average particle size of from 8 nm to 80 nm.

10. The nanostructured electrode of claim 1, wherein the BET surface area of the nanostructured electrode is from 15 m²/g to 70 m²/g.

11. The nanostructured electrode of claim 1, wherein the nanostructured electrode has a photocurrent density of from 0.25 mA/cm² to 10 mA/cm² at a 1 V potential and/or at a 1.23 V potential (vs. RHE).

12. The nanostructured electrode of claim 1, wherein the nanostructured electrode has a current onset potential of from 0.2 V to 0.31 V vs. RHE.

13. The nanostructured electrode of claim 1, wherein the nanostructured electrode has a solar energy conversion efficiency of from 0.2% to 5% at a 0.8 V potential (vs. RHE).

14. The nanostructured electrode of claim 1, wherein the nanostructured electrode has an incident photon-to-current conversion efficiency (IPCE) of 20% or more.

15. A method of use of a photoelectrochemical cell for a water splitting reaction, the photoelectrochemical cell comprising:
a working electrode comprising the nanostructured electrode of claim 1 in electrochemical contact with a liquid sample, wherein the liquid sample comprises water; and
one or more additional electrodes in electrochemical contact with the liquid sample.

16. The method of claim 15, wherein the water splitting reaction produces H₂ at a rate of from 30 μmol·h⁻¹·cm⁻² to 80 μmol·h⁻¹·cm⁻² at 1.0 V (vs. RHE).

17. The method of claim 15, wherein the water splitting reaction produces O₂ at a rate of from 15 μmol·h⁻¹·cm⁻² to 40 μmol·h⁻¹·cm⁻² at 1.0 V (vs. RHE).

18. The method of claim 15, wherein H₂ and/or O₂ is produced with a Faraday efficiency of 90% or more.

19. A method of making the nanostructured electrode claim 1, the method comprising depositing a plurality of plasmonic particles on the nanostructured semiconductor, thereby forming the nanostructured electrode.

20. The method of claim 19, wherein the method further comprises forming the nanostructured semiconductor by
electrodepositing a first semiconductor precursor on a substrate, thereby forming a nanostructured semiconductor precursor film;
contacting the nanostructured semiconductor precursor film with a second semiconductor precursor, thereby forming an impregnated nanostructured semiconductor precursor film; and
thermally annealing the impregnated nanostructured semiconductor precursor film, thereby forming the nanostructured semiconductor.

21. The method of claim 20, wherein the first semiconductor precursor comprises BiOI.

22. The method of claim 20, wherein the nanostructured semiconductor precursor film comprises an array of BiOI nanoflakes.

23. The method of claim 20, wherein the second semiconductor precursor comprises a vanadium compound.

24. The method of claim 20, wherein the nanostructured semiconductor comprises BiVO₄.

25. The method of claim 19, wherein depositing the plurality of plasmonic particles comprises:
contacting the nanostructured semiconductor with a plasmonic particle precursor, thereby forming a nanostructured electrode precursor; and
thermally annealing the nanostructured electrode precursor to form the nanostructured electrode.
